(19) United States
(12) Patent Application Publication
(10) Pub. No.: US 2026/0126352 A1
(43) Pub. Date: May 7, 2026

(54) MULTI-ZONE SMOKE DETECTOR FOR VEHICLE AND FIRE EXTINGUISHING SYSTEM INCLUDING THE SAME

(71) Applicants: HYUNDAI MOTOR COMPANY, SEOUL (KR); KIA CORPORATION, SEOUL (KR)

(72) Inventor: Hyeon Gi Shin, Hwaseong-si (KR)

(73) Assignees: HYUNDAI MOTOR COMPANY, SEOUL (KR); KIA CORPORATION, SEOUL (KR)

(21) Appl. No.: 19/197,188

(22) Filed: May 2, 2025

(30) Foreign Application Priority Data
Nov. 6, 2024 (KR) 10-2024-0155863

(51) Int. Cl. G01N 1/26; A62C 3/07; A62C 37/40; G01N 1/24; G01N 15/00; G01N 15/075

(52) U.S. Cl. CPC G01N 1/26; A62C 3/07; A62C 37/40; G01N 1/24; G01N 15/075; G01N 2015/0046

(57) ABSTRACT

A multi-zone smoke detector includes a housing connected to a smoke detection pipe and provided to allow air or air containing smoke flowing in from a fire monitoring zone to pass through the smoke detection pipe, a light-emitting element provided in the housing, and a plurality of light-receiving elements that are provided in the housing to face the light-emitting element and convert light received from the light-emitting element into an electrical signal and output the result. The housing includes a plurality of sensing chambers, each of which is provided for each fire monitoring zone to allow the air or air containing smoke flowing in through the smoke detection pipe from each fire monitoring zone to pass therethrough, each of which is connected to the smoke detection pipe, and each of which is provided with the light-receiving element.

### CROSS REFERENCE TO RELATED APPLICATIONS

This application claims under 35 U.S.C. § 119(a), the benefit of priority to Korean Patent Application No. 10-2024-0155863 filed on Nov. 6, 2024, the entire contents of which are incorporated herein by reference.

### BACKGROUND

### (a) Technical Field

The present disclosure relates to a smoke detector capable of monitoring the occurrence of a fire in a plurality of zones provided in a vehicle, and accurately distinguishing and determining a zone in which a fire occurs among the plurality of zones, and a fire extinguishing system for a vehicle capable of quickly and automatically suppressing a fire occurring in the vehicle using the smoke detector.

### (b) Background Art

In general, vehicles use flammable fuel, have multiple heat sources, and have various intertwined electrical wires, so there is a constant risk of fire.

For example, since a high-temperature engine and various electrical devices are provided in an engine compartment of a vehicle, the engine and electrical devices may be damaged or malfunction due to a collision accident or the like, thereby resulting in a fire. Further, in the engine compartment, there is a risk of fire during driving due to engine overheating or exhaust gas post-treatment.

In order to prepare for such a risk, a fire extinguisher is generally known. However, in a case where a driver fails to use the fire extinguisher in time, since it is difficult to extinguish the fire, the fire may spread throughout the vehicle.

Moreover, in the case of a public transportation vehicle such as a bus in which many passengers ride, fire prevention management is essential for passenger safety since fire occurring in such a public transportation vehicle may lead to a large-scale disaster.

In addition, since the driver is inside the vehicle during driving, even in a case where fire occurs in the engine compartment, the fire may not be noticed until a large amount of smoke is generated. In particular, since an engine compartment of a bus is located at the rear of the vehicle, unlike a passenger car, it is more difficult for the driver to notice the engine compartment fire.

Therefore, in a case where the driver fails to quickly take action to extinguish the fire in an early stage, the fire may spread and lead to total loss of the vehicle, which may increase the risk of casualties. Additionally, even in a case where the driver or passengers inside the vehicle are aware of the fire, it is difficult to extinguish the fire using only the small fire extinguisher provided in the vehicle.

Recently, as the use of eco-friendly vehicles such as electric vehicles and fuel cell vehicles increases, the risk of fire in batteries or high-voltage electrical wires due to external impact or internal short circuits is increasing.

In particular, in the case of a large electric bus (xEV), a PE (Power Electric) compartment where various electric devices and electrical wires are provided is located at the rear of the vehicle instead of an engine compartment. FIG. 1 is a diagram briefly showing a PE compartment 2 of a vehicle 1 such as an electric bus.

As shown in FIG. 1, in the PE compartment 2, electric components (PE components) and electrical wires are provided in a complex manner. Although not shown in detail in the diagram, a motor for driving a vehicle, an LDC (Low voltage DC-DC Converter) that is a power conversion system, low voltage/high voltage wires, a water heater, a junction box, an air compressor, a cooling module, etc. are provided therein.

As a result of analysis of a fire occurrence probability in the devices or components provided in the PE compartment 2, it is known that the fire occurrence probability is the highest in the low-voltage/high-voltage wires.

As a result of a fire simulation test conducted by increasing electric current by 100 A using the low-voltage/high-voltage wires, smoke was generated at a part where a connector and a cable were in contact, and it was found that a gas (smoke) detector was suitable as a fire detection sensor in the PE compartment 2.

Using a flame detector as a fire detection sensor is the most accurate method, but the flame detector cannot detect fire in its early stage, and can detect the fire only when the fire spreads to a certain extent.

Since a temperature detector can only detect a rise in temperature at its installation location, it is not possible to cover the entire space of the PE compartment for fire detection with a small number of temperature detectors, and in a case where a large number of temperature detectors is provided in the PE compartment, the layout becomes complicated.

A smoke detector may be used as a fire detection sensor in the PE compartment 2 of the electric bus, but a problem when using the gas (smoke) detector is the presence of a cooling fan (electric fan). In a case where fire occurs while the cooling fan is in operation, smoke may not move to the smoke detector due to the cooling fan.

Among devices that make up a cooling module, the cooling fan is a device that supplies air to a radiator. The cooling fan is provided on a rear side of the vehicle 1 as shown in FIG. 1, and suctions in outside air and supplies the same to the PE compartment 2.

Here, forced convection of air occurs inside the PE compartment 2 by the air supplied by the cooling fan, and as the air moves strongly in one direction, the smoke generated here also moves.

In this case, the smoke detector should be able to detect the fire by detecting smoke when fire breaks out. However, in a case where fire occurs at the time when the cooling fan is operating, the smoke is more likely to not reach the smoke detector due to the air blown by the cooling fan, and thus, the fire may not be detected by the smoke detector.

In addition, in a case where a driver wants to monitor fire occurrence in multiple areas of the vehicle, a plurality of smoke detectors is required, which increases the installation cost of fire extinguishing systems including smoke detectors, which is disadvantageous in terms of vehicle cost.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the-described problems associated with prior art, and an object of the present disclosure is to provide a fire extinguishing system for a vehicle capable of accurately detecting fire occurring in the vehicle and quickly and automatically extinguishing the fire.

In particular, an aspect of the present disclosure is to provide a fire detector capable of monitoring a fire occurrence in a plurality of zones provided in the vehicle and accurately distinguishing and determining a zone where a fire occurs among the plurality of zones, and a fire extinguishing system including the same capable of quickly and automatically suppressing the fire in the vehicle using the smoke detector.

In one aspect, the present disclosure provides a multi-zone smoke detector including a housing connected to a smoke detection pipe and configured to allow air or air containing smoke flowing in from a fire monitoring zone to pass through the smoke detection pipe, a light-emitting element provided in the housing, and a plurality of light-receiving elements provided in the housing to face the light-emitting element, converting light received from the light-emitting element into an electrical signal and outputting the result, in which the housing includes a plurality of sensing chambers, each of which is provided for each fire monitoring zone to allow the air or air containing smoke flowing in through the smoke detection pipe from each of the plurality of fire monitoring zones to pass therethrough, each of which is connected to the smoke detection pipe, and each of which is provided with the light-receiving element.

In an embodiment, the plurality of sensing chambers and the plurality of light-receiving elements may be arranged centered around the light-emitting element.

In another embodiment, the plurality of sensing chambers may be arranged at equal intervals around the light-emitting element.

In still another embodiment, the light-emitting element may be provided in a cylindrical shape, a plurality of grooves may be formed on a circumference of the light-emitting element, in which a sensing chamber boundary portion that divides adjacent sensing chambers in the housing is fitted, and light is blocked between the adjacent sensing chambers by a structure in which each boundary portion of the housing is fitted in each groove of the light-emitting element.

In yet another embodiment, each of the grooves may extend in a lengthwise direction of the light-emitting element on the circumference of the light-emitting element.

In still yet another embodiment, the light-receiving element may be in the form of a plate of a predetermined thickness, and is provided on an inner surface of each sensing chamber at a position opposite to the light-emitting element.

In a further embodiment, the housing may be provided in a “□” shape, the light-emitting element may be provided at the center of the housing having the “□” shape, and the sensing chamber and the light-receiving element may be respectively arranged at four locations centered around the light-emitting element.

In another further embodiment, an inlet port to which the smoke detection pipe is connected and through which air or air containing smoke flows in may be provided at the front of each sensing chamber, in the housing, and an exhaust port through which the air or the air containing smoke having passed through the interior of the sensing chamber is discharged may be provided at the rear of each sensing chamber.

In another aspect, the present disclosure provides a fire extinguishing system for a vehicle including a smoke suctioning and a fire extinguishing fluid discharge pipe, each of which is provided in a plurality of fire monitoring zones provided in the vehicle, and is provided with a nozzle for spraying a fire extinguishing fluid, a smoke detection pipe connected to the smoke suctioning and fire extinguishing fluid discharge pipe through a control valve to selectively communicate with the smoke suctioning and fire extinguishing fluid discharge pipe, an air compressor configured to apply suction pressure to the smoke detection pipe, a multi-zone smoke detector provided to detect smoke in air flowing in through the nozzle and the smoke suctioning and fire extinguishing fluid discharge pipe from each of the plurality of fire monitoring zones by the suction pressure of the air compressor acting on the smoke suctioning and fire extinguishing fluid discharge pipe through the smoke detection pipe, a controller that determines that fire occurs in a case where the smoke is detected through the smoke detector, and outputs a control signal for spraying the fire extinguishing fluid to a fire monitoring zone where the fire occurs through the nozzle, and a fire extinguishing fluid supply device provided to supply the fire extinguishing fluid to the smoke suctioning and fire extinguishing fluid discharge pipe within the fire monitoring zone where the fire occurs according to the control signal output from the controller.

In an embodiment, the plurality of fire monitoring zones may include one or more of a PE compartment in which power electric (PE) parts are provided, a battery compartment in which a battery is provided, and a stack compartment in which a fuel cell stack is provided.

In another embodiment, a fire extinguishing fluid supply pipe that supplies the fire extinguishing fluid from the fire extinguishing fluid supply device may be branched and extended to each of the fire monitoring zones, and each of the branched extinguishing fluid supply pipes may be connected through the control valve so as to selectively communicate with the smoke suctioning and fire extinguishing fluid discharge pipe within each of the fire monitoring zones.

In still another embodiment, each of the branched fire extinguishing fluid supply pipes, the smoke suctioning and fire extinguishing fluid discharge pipe in each of the fire monitoring zones, and the smoke detection pipe provided for each of the fire monitoring zones may be connected via each control valve, and an opening state of each control valve may be controlled by the controller to allow communication between the fire extinguishing fluid supply pipe and the smoke suctioning and fire extinguishing fluid discharge pipe or communication between the smoke detection pipe and the smoke suctioning and fire extinguishing fluid discharge pipe.

In yet another embodiment, the multi-zone smoke detector may include a housing connected to the smoke detection pipe and provided to allow air or air containing smoke flowing in from the fire monitoring zone to pass through the smoke detection pipe, a light-emitting element provided in the housing, and a plurality of light-receiving elements provided in the housing to face the light-emitting element, converting light received from the light-emitting element into an electrical signal and outputting the result, in which the housing includes a plurality of sensing chambers, each of which is provided for each fire monitoring zone to allow air or air containing smoke flowing in through each of the smoke detection pipes from each of the plurality of fire monitoring zones to pass therethrough, each of which is connected to each of the smoke detection pipes, and each of which has the light-receiving element provided therein.

In still yet another embodiment, the plurality of sensing chambers and the plurality of light-receiving elements may be centered around the light-emitting element.

In a further embodiment, the light-emitting element may have a cylindrical shape, a plurality of grooves may be formed on a circumference of the light-emitting element, a sensing chamber boundary portion that divides adjacent sensing chambers in the housing is fitted in each groove, and light may be blocked between the adjacent sensing chambers in a state where each boundary portion of the housing is fitted in each groove of the light-emitting element.

In another further embodiment, an inlet port to which the smoke detection pipe is connected and through which air or air containing smoke flows in may be provided at the front of each sensing chamber, in the housing, and an exhaust port through which the air or the air containing smoke having passed through the interior of the sensing chamber is discharged may be provided at the rear of each sensing chamber.

In still another further embodiment, the smoke detection pipes connected to the outlet ports may be combined and connected to the suction pipe, and the suction pipe is connected to the air compressor so that the suction pressure of the air compressor is applied to each smoke detection pipe through the suction pipe.

In yet another further embodiment, the fire extinguishing fluid supply device may include a fire extinguishing fluid tank in which the fire extinguishing fluid is stored, and a pressure transfer plate that moves by pressure of the fire extinguishing fluid supplied to a pressure chamber of the fire extinguishing fluid tank, and pressurizes the fire extinguishing fluid filled in a fire extinguishing fluid chamber of the fire extinguishing fluid tank to discharge the fire extinguishing fluid to the fire extinguishing fluid supply pipe from the fire extinguishing fluid tank, in which the working fluid is compressed air supplied by the air compressor.

In still yet another further embodiment, the nozzle may include a nozzle pipe having a first end portion connected to communicate with each smoke suctioning and fire extinguishing fluid discharge pipe and a second end portion through which air or air containing smoke within the fire monitoring zone flows in or the fire extinguishing fluid is discharged and sprayed, and a filter member provided in the nozzle pipe to remove foreign substances contained in the air or air and smoke suctioned through the second end portion of the nozzle pipe by the suction pressure of the air compressor.

In a still further embodiment, the controller may determine the concentration of smoke in the air flowing in from each of the plurality of fire monitoring zones on the basis of an electrical signal of the multi-zone smoke detector indicating the concentration of smoke in the air flowing in from each of the plurality of fire monitoring zones, a speed (RPM) of the air compressor, and a speed (RPM) of a cooling fan provided in each fire monitoring zone.

Other aspects and preferred embodiments of the disclosure are discussed infra.

It is understood that the term “vehicle” or other similar term as used herein is inclusive of motor vehicles in general such as passenger automobiles including sport utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example, a vehicle powered by both gasoline and electricity.

### BRIEF DESCRIPTION OF THE FIGURES

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a diagram for illustrating occurrence of forced convection of air inside a PE compartment by a cooling fan in a typical electric bus;

FIG. 2 is a block diagram showing a configuration of a fire extinguishing system according to an embodiment of the present disclosure;

FIG. 3 is a diagram showing a state in which a smoke suctioning and fire extinguishing fluid discharge pipe of a fire extinguishing system according to an embodiment of the present disclosure is provided in a PE compartment;

FIG. 4 is a diagram showing a state in which a smoke suctioning and fire extinguishing fluid discharge pipe of a fire extinguishing system according to an embodiment of the present disclosure is provided in a battery compartment;

FIG. 5 is a diagram showing a configuration of a fire extinguishing system according to an embodiment of the present disclosure;

FIG. 6 is a diagram showing a photoelectric smoke detector having a light-emitting element and a light-receiving element according to an embodiment of the present disclosure;

FIG. 7 is a diagram showing a configuration of a nozzle provided in a smoke suctioning and fire extinguishing fluid discharge pipe according to an embodiment of the present disclosure;

FIG. 8 is a diagram showing an operating state of the nozzle in a fire detection mode according to an embodiment of the present disclosure;

FIG. 9 is a diagram showing an operating state of the nozzle when spraying a fire extinguishing fluid according to an embodiment of the present disclosure;

FIG. 10 is a diagram showing an operating state in the fire detection mode of the fire extinguishing system shown in FIG. 5;

FIG. 11 is a diagram showing an operating state in fire detection in a PE compartment of the fire extinguishing system shown in FIG. 5;

FIG. 12 is a diagram showing an operating state in fire detection in a battery compartment of the fire extinguishing system shown in FIG. 5;

FIG. 13 is a diagram for illustrating a method of controlling an air compressor by a controller of the fire extinguishing system according to the embodiment of the present disclosure;

FIG. 14 is a diagram for illustrating a method of detecting fire by the controller of the fire extinguishing system according to the embodiment of the present disclosure;

FIG. 15 is a diagram for illustrating a control state in fire detection of the fire extinguishing system according to the embodiment of the present disclosure;

FIG. 16 is a diagram showing a configuration of a fire extinguishing system using a multi-zone smoke detector according to another embodiment of the present disclosure;

FIG. 17 is a diagram showing an operating state of the fire extinguishing system shown in FIG. 16;

FIG. 18 is a perspective view showing the multi-zone smoke detector according to the embodiment of the present disclosure; and

FIG. 19 is a cross-sectional view showing a configuration of the multi-zone smoke detector according to the embodiment of the present disclosure.

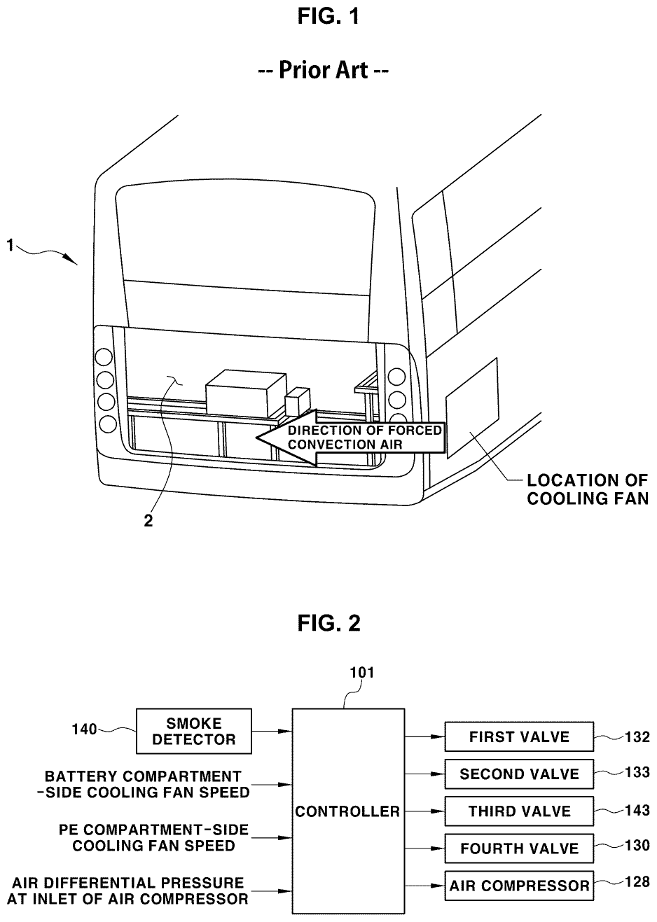

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure will be described in detail with reference to the accompanying diagrams. Specific structural or functional descriptions presented in the embodiments of the present disclosure are merely exemplified for the purpose of describing embodiments according to the concept of the present disclosure, and embodiments according to the concept of the present disclosure may be implemented in various forms. The present disclosure should not be construed as limited to the embodiments described in this specification, but should be understood to include all modifications, equivalents, or substitutes included in the concept and technical scope of the present disclosure.

It will be understood that, although the terms “first”, “second”, etc. may be used herein to describe various elements, these elements should not be limited by these terms. These terms are only used to distinguish one element from another. For example, a first element may be termed a second element, and, similarly, a second element may be termed a first element, without departing from the scope of the exemplary embodiments of the present disclosure.

In addition, it will be understood that, when an element is “connected” or “coupled” to another element, it may be directly connected or coupled to the other element, or may be indirectly connected or coupled to the other element with a different element being interposed therebetween. In contrast, when an element is “directly connected” or “directly coupled” to another element, this means that there is no intervening element therebetween. Other expressions used to describe the relationship between elements should be interpreted in a similar manner (for example, “between” and “directly between”, “adjacent” and “directly adjacent”, etc.).

Wherever possible, the same reference numbers will be used throughout the diagrams to refer to the same or like parts. The terminology used herein is for the purpose of describing particular embodiments only and is not intended to limit exemplary embodiments of the disclosure. As used herein, the singular forms “a”, “an”, and “the” are intended to include the plural forms as well, unless the context clearly indicates otherwise. It will be further understood that the terms “comprise”, “include”, and “have” used herein specify the presence of stated components, steps, operations, and/or elements, but do not preclude the presence or addition of one or more other components, steps, operations, and/or elements.

The present disclosure relates to a fire extinguishing system for a vehicle, capable of accurately detecting fire occurring in the vehicle and quickly and automatically extinguishing the fire. Here, the vehicle may be a large vehicle, for example, a bus.

More specifically, the vehicle may be a vehicle that runs by driving a motor by battery power, for example, an electric vehicle (xEV) such as a hydrogen electric bus (fuel cell bus) or a battery electric bus.

A fire extinguishing system according to an embodiment of the present disclosure may be a fire extinguishing system capable of detecting and extinguishing fire occurring in a PE compartment located at the rear of a vehicle, or may be a fire extinguishing system capable of detecting and extinguishing fire occurring in a battery compartment, for example, a battery compartment provided on an upper side of a vehicle roof.

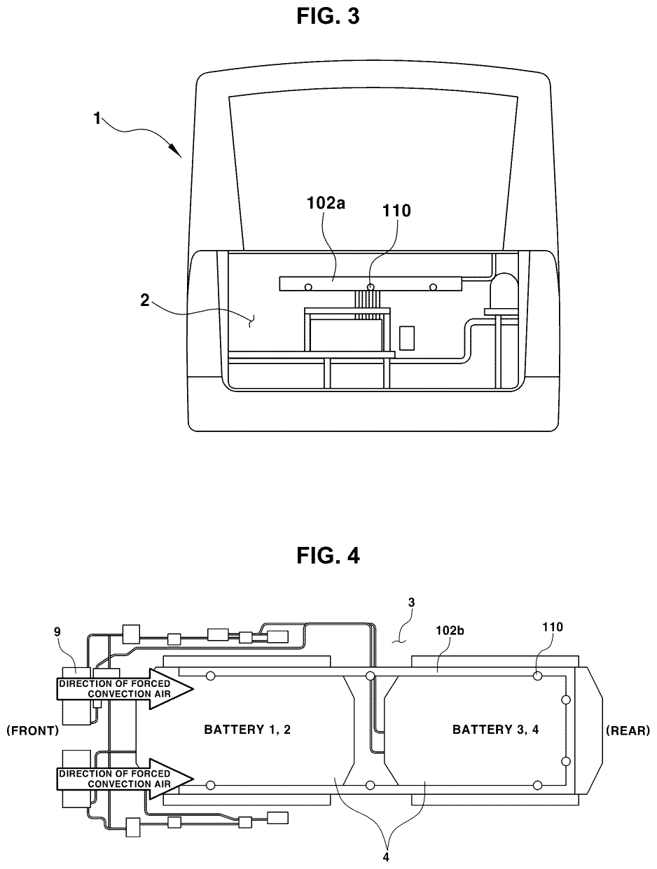

FIG. 2 is a block diagram showing a configuration of a fire extinguishing system according to an embodiment of the present disclosure, and FIG. 3 is a diagram showing a state in which a smoke suctioning and fire extinguishing fluid discharge pipe of the fire extinguishing system according to the embodiment of the present disclosure is provided within a PE compartment.

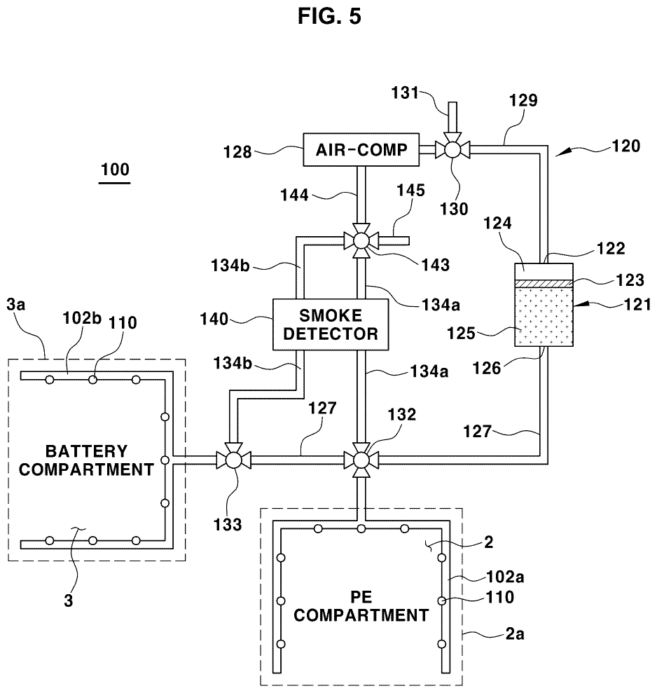

The fire extinguishing system according to the present disclosure may be configured in a PE compartment 2 at the rear of a vehicle 1, and a smoke suctioning and fire extinguishing fluid discharge pipe 102a is provided in the PE compartment 2. Here, the smoke suctioning and fire extinguishing fluid discharge pipe may be provided in a PE compartment cover 2a (in FIG. 5).

The smoke suctioning and fire extinguishing fluid discharge pipe 102a is a member that suctions smoke for fire detection within the PE compartment 2 and supplies, sprays, and discharges a fire extinguishing fluid for fire suppression.

In the present embodiment, the smoke suctioning and fire extinguishing fluid discharge pipe 102a may be generally U-shaped (see FIG. 5) in an upper space within the PE compartment 2 to spray the fire extinguishing fluid downwardly toward the electric components (PE components) within the PE compartment 2.

In the present embodiment, the smoke suctioning and fire extinguishing fluid discharge pipe 102a may have a plurality of nozzles 110, and may forcibly suction smoke generated by fire in the PE compartment 2 together with air through each nozzle 110.

In the present disclosure, in a case where fire in the PE compartment 2 is detected using a smoke detector 150 from smoke forcibly suctioned through the smoke suctioning and fire extinguishing fluid discharge pipe 102a, the fire extinguishing fluid is supplied through the smoke suctioning and fire extinguishing fluid discharge pipe 102a so that the fire extinguishing fluid is sprayed and discharged through the nozzle 110 into the PE compartment 2.

FIG. 4 is a diagram showing a state in which a smoke suctioning and fire extinguishing fluid discharge pipe of a fire extinguishing system according to an embodiment of the present disclosure is provided in a battery compartment. The fire extinguishing system according to the present disclosure may be provided in a battery compartment 3 on an upper side of a vehicle roof, and a smoke suctioning and extinguishing fluid discharge pipe 102b may be provided in the battery compartment 3.

Referring to FIG. 4, it may be seen that a battery pack assembly 4 is provided at front and rear positions in a front-back direction of the vehicle, and the smoke suctioning and fire extinguishing fluid discharge pipe 102b having an approximately U-shape is provided together with heat management components such as a cooling fan 9 of a cooling module.

The smoke suctioning and fire extinguishing fluid discharge pipe 102b suctions smoke to detect fire in the battery compartment 3, and supplies, sprays, and discharges the fire extinguishing fluid to suppress the fire. The smoke suctioning and fire extinguishing fluid discharge pipe 102b may be provided in an upper space within the battery compartment 3.

The smoke suctioning and fire extinguishing fluid discharge pipe 102b may be generally U-shaped in the upper space within the battery compartment 3 so as to spray the fire extinguishing fluid downwardly toward the battery pack assembly 4 in the battery compartment 3.

For example, the smoke suctioning and fire extinguishing fluid discharge pipe 102b may be provided in a structure 3a (in FIG. 5) such as a battery cover located in the upper space within the battery compartment 3.

In an embodiment of the present disclosure, the smoke suctioning and fire extinguishing fluid discharge pipe 102b in the battery compartment 3 may have a plurality of nozzles 110 for smoke suction, and may suction smoke generated in the battery compartment 3 when a fire breaks out together with air through each nozzle 110.

In a case where the fire in the battery compartment 3 is detected using the smoke detector 150 from the smoke suctioned through the smoke suctioning and fire extinguishing fluid discharge pipe 102b, the fire extinguishing fluid is supplied through the smoke suctioning and fire extinguishing fluid discharge pipe 102b so that the fire extinguishing fluid can be sprayed and discharged through each nozzle 110 within the battery compartment 3. In the case of the battery compartment 3, a large amount of flammable gas is generated and released when fire occurs, and a smoke detector is suitable as a sensor for early detection of the fire.

In the case of the battery compartment 3, the cooling fan 9 of the cooling module is mounted at the front of the vehicle 1 to generate forced convection of air and suctions outside air from the front of the vehicle 1 and supplies the air to the rear. The direction of forced convection is a direction in which the air moves from the front to the rear as shown in FIG. 4.

When the cooling fan is operated, since the forced convection of air occurs within the battery compartment 3, in a case where the smoke detector 150 (in FIG. 2) for fire detection is provided within the battery compartment 3, smoke from fire may not flow toward the smoke detector 150 due to the forced convection of air by the cooling fan, and thus, the smoke detector 150 may not detect the occurrence of the fire in time.

Accordingly, as in the PE compartment 2, the smoke suctioning and fire extinguishing fluid discharge pipe 102b is provided in the battery compartment 3, so that smoke generated by fire is forcibly suctioned into the smoke suctioning and fire extinguishing fluid discharge pipe 102b and then detected by the smoke detector 150 on a pipe (smoke detection pipe) connected to the smoke suctioning and fire extinguishing fluid discharge pipe, thereby enabling smoke to be accurately detected at the time of fire in the space, regardless of the operation of the cooling fan 9 or the occurrence of forced convection.

The smoke detector 150 may be provided in a location that is not affected by forced convection by the cooling fan 9, and for example, may be provided outside the PE compartment 2 and the battery compartment 3, not inside the PE compartment 2 and battery compartment 3.

In the present disclosure, there is no difference in the operating state, function, or use of the smoke suctioning and fire extinguishing fluid discharge pipe 102a or 102b between a case where it is provided in the PE compartment 2 and a case where it is provided in the battery compartment 3. That is, the smoke suctioning and fire extinguishing fluid discharge pipe 102a or 102b has the same function and operation in a case where it is provided in the PE compartment 2 and in a case where it is provided in the battery compartment 3.

FIG. 5 is a diagram showing configuration of a fire extinguishing system according to an embodiment of the present disclosure, and shows an example in which the PE compartment 2 and the battery compartment 3 are set as a fire monitoring space and a fire response space for suppressing a fire in the vehicle 1.

Here, the vehicle may be an electric vehicle or a fuel cell vehicle. In these vehicles, the fire response space (fire monitoring space) may include one or two of the PE compartment and the battery compartment.

More specifically, in the present disclosure, the smoke suctioning and fire extinguishing fluid discharge pipe may be provided in the PE compartment 2 or the battery compartment 3, or may be provided in both the PE compartment 2 and the battery compartment 3.

In the embodiment of FIG. 5, one PE compartment 2 and one battery compartment 3 are set as the fire response spaces of the vehicle where the extinguishing fluid is sprayed by the fire extinguishing system 100, but fire response spaces other than the PE compartment and the battery compartment may be set within the vehicle, or two or more PE compartments or two or more of battery compartments may be set as the fire response spaces.

In this way, the smoke suctioning and fire extinguishing fluid discharge pipe 102a or 102b may be provided in the fire response space set in advance in the vehicle 1 to extinguish fire. To this end, as described above, one or more fire response spaces may be provided.

As shown in FIG. 5, the smoke suctioning and fire extinguishing fluid discharge pipe 102a or 102b may be generally U-shaped on a PE compartment cover 2a or a battery compartment cover 3a, and a nozzle 110 that sprays a fire extinguishing fluid may be provided at preset intervals in the length direction.

In the smoke suctioning and fire extinguishing fluid discharge pipe 102a or 102b, the nozzles 110 may be provided at regular intervals in the length direction, and the smoke suctioning and fire extinguishing fluid discharge pipe 102a or 102b and the nozzles 110 may be provided in the upper space within the PE compartment 2 and the battery compartment 3 so as to spray the fire extinguishing fluid downwardly toward the electrical components (PE components) or a battery pack assembly where fire occurs.

A fire extinguishing fluid supply pipe 127 is connected to the smoke suctioning and fire extinguishing fluid discharge pipes 102a and 102b provided in the respective fire response spaces of the PE compartment 2 and the battery compartment 3. Further, the fire extinguishing fluid supply pipe 127 is connected to a fire extinguishing fluid supply device 120.

That is, the fire extinguishing fluid supply pipe 127 is extended to each fire response space of the PE compartment 2 and the battery compartment 3 to supply the fire extinguishing fluid from the fire extinguishing fluid supply device 120, and is connected to the smoke suctioning and fire extinguishing fluid discharge pipes 102a and 102b.

In addition, smoke detection pipes 134a and 134b are branched at separate locations of the fire extinguishing fluid supply pipe 127. Each of the smoke detection pipes 134a and 134b is extended to pass through the smoke detector 150. The two smoke detection pipes 134a and 134b that pass through the smoke detector 150 are combined into one pipe and then connected to an air compressor 128.

A multi-way valve is provided at each location where the smoke detection pipes 134a and 134b are branched from the fire extinguishing fluid supply pipe 127. For example, a 3-way valve or a 4-way valve may be provided according to the number of branches.

For example, as shown in FIG. 5, a multi-way valve 132 (referred to hereinafter as a “first control valve”) in the form of a 4-way valve is provided at a location where there are four branches of the fire extinguishing fluid supply pipe 127 connected from the fire extinguishing fluid supply device 120, the PE compartment-side smoke suctioning and fire extinguishing fluid discharge pipe 102a, the PE compartment-side smoke detection pipe 134a connected to the smoke detector 150, and the battery compartment-side smoke suctioning and fire extinguishing fluid discharge pipe 102b (i.e., connected to a second control valve to be described later,.

In addition, a multi-way valve 133 (referred to hereinafter as the “second control valve”) in the form of a 3-way valve is provided at a location where there are three branches of the fire extinguishing fluid supply pipe 127 connected from the first control valve 132, the battery compartment-side smoke suctioning and fire extinguishing fluid discharge pipe 102b, and the battery compartment-side smoke detection pipe 134b connected to the smoke detector 150.

Further, an intake port 145 extended to the atmosphere is branched at a location where the smoke detection pipes 134a and 134b of the two fire response spaces that pass through the smoke detector 150 are combined on an exit side of the smoke detector 150, that is, on a rear end side of the smoke detector 150.

A multi-way valve 143 (referred to hereinafter as an “intake valve”) in the form of a 4-way valve is provided at the location where the smoke detection pipes 134 a and 134 b are combined, and there are four branches including a suction pipe 144 connected to an inlet of the air compressor 128.

That is, on the rear end side of the smoke detector 150, the smoke detection pipes 134a and 134b extended from the fire response spaces and the suction pipe 144 connected to the inlet port of the air compressor 128 are connected via the intake valve 143, and the intake port is additionally connected to the intake valve 143 so as to be selectively connected to the suction pipe 144.

Further, in the embodiment of the present disclosure, the fire extinguishing fluid supply device 120 is configured to include a fire extinguishing fluid tank 121 in which the fire extinguishing fluid is stored, and a pressure transfer plate 123 that pressurizes the fire extinguishing fluid by pressure of a working fluid supplied to a pressure chamber 124 of the fire extinguishing fluid tank 121 to discharge the fire extinguishing fluid to the fire extinguishing fluid supply pipe 127 in a high-pressure state.

The pressure transfer plate 123 is provided transversely in an internal space of the fire extinguishing fluid tank 121 to divide the internal space of the fire extinguishing fluid tank 121 into front and rear sections. In particular, the pressure transfer plate 123 is provided to move forward and backward in a state of being transversely provided in the internal space of the fire extinguishing fluid tank 121.

In the internal space of the fire extinguishing fluid tank 121, among two spaces divided by the pressure transfer plate 123, that is, a space in front of the pressure transfer plate 123 is a fire extinguishing fluid chamber 125 which is filled with the fire extinguishing fluid, and a space behind the pressure transfer plate 123 is the pressure chamber 124 where the working fluid is supplied and the pressure of the working fluid is applied.

Here, the working fluid may be compressed air supplied by the air compressor 128. To this end, an air inlet port 122 connected to the pressure chamber 124 is provided at a rear end portion of the fire extinguishing fluid tank 121 where the pressure chamber 124 is located at the rear of the pressure transfer plate 123, and an air supply pipe 129 through which compressed air is supplied from the air compressor 128 is connected to the air inlet port 122.

The air supply pipe 129 is connected between an outlet (not shown) through which compressed air is discharged from an air compressor 128 and the air inlet port 122 of the fire extinguishing fluid tank 121. A multi-way valve (referred to hereinafter as an “exhaust valve”) of 3-way valve type is provided in the middle of the air supply pipe 129, and an exhaust port 131 may be connected to the exhaust valve 130 to be selectively connected to the air supply pipe 129.

The fire extinguishing fluid supply pipe 127 is connected to a fire extinguishing fluid outlet port 126 provided in the fire extinguishing fluid chamber 125 in front of the pressure transfer plate 123 in the fire extinguishing fluid tank 121. The fire extinguishing fluid supply pipe 127 is connected to the fire response spaces, that is, the PE compartment 2 and the battery compartment 3.

Specifically, the fire extinguishing fluid supply pipe 127 is connected to the smoke suctioning and fire extinguishing fluid discharge pipes 102a and 102b provided in the fire response spaces, that is, the PE compartment 2 and the battery compartment 3 from the fire extinguishing fluid outlet port 126 of the fire extinguishing fluid tank 121.

Accordingly, the fire extinguishing fluid in the fire extinguishing fluid tank 121 may be discharged through the fire extinguishing fluid outlet port 126 to the fire extinguishing fluid supply pipe 127, and then, may move along the fire extinguishing fluid supply pipe 127 to be supplied to the smoke suctioning and fire extinguishing fluid discharge pipe 102a or 102b in each fire response space (PE compartment and battery compartment).

Then, the fire extinguishing fluid supplied to the smoke suctioning and fire extinguishing fluid discharge pipe 102a or 102b may be sprayed into the interior of the fire response space through the nozzle 110 provided at each location, thereby making it possible to extinguish fire using the fire extinguishing fluid.

In the present disclosure, the air compressor 128 is a component that provides suction pressure for fire detection to the smoke suctioning and fire extinguishing fluid discharge pipes 102a and 102b, and is a component that supplies the working fluid to the fire extinguishing fluid tank 121 of the fire extinguishing fluid supply device. The operations of the air compressor 128, the first control valve 132, the second control valve 133, the intake valve 143, and the exhaust valve 130 are controlled by a control signal output from a controller 101 (see FIG. 2).

In the present disclosure, in a case where it is determined that fire occurs in a fire response space from an electrical signal input from the smoke detector 150, the controller 101 outputs a control signal for fire suppression. Accordingly, the operations of the air compressor 128 and the multi-way valves (130, 132, 133 and 143) are controlled to extinguish the fire occurring in the fire response space according to the control signal.

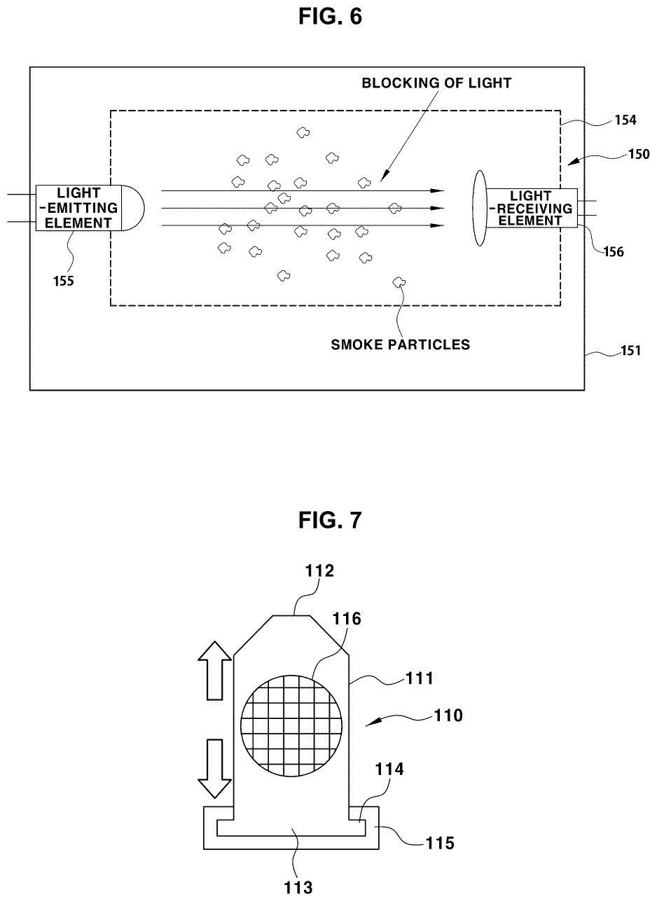

FIG. 6 is a diagram showing a photoelectric smoke detector having a light-emitting element and a light-receiving element according to an embodiment of the present disclosure. An operating principle of the smoke detector 150 will be described with reference to FIG. 6.

In the present disclosure, the smoke detector 150 may include a housing 151 having a sensing chamber 154 through which the smoke detection pipes 134a and 134b are connected and through which air or air containing smoke flowing in through the smoke detection tubes 134a and 134b passes, and a smoke detection sensor that is provided in an internal space of the housing 151 to detect smoke in the air passing through the sensing chamber 154 and output an electrical signal according to the detection result.

In an embodiment of the present disclosure, the smoke detection sensor may be a photoelectric sensor, and the smoke detector 150 may be a photoelectric smoke detector. The photoelectric sensor uses the principle that smoke particles block or reflect light, and may be configured to include a light-emitting element 155 and a light-receiving element 156.

As shown in FIG. 6, the photoelectric sensor may include the light-emitting element 155 provided on one side of the sensing chamber 154 of the housing 151, and the light-receiving element 156 provided on the other side of the sensing chamber 154 of the housing 151 so as to face the light-emitting element 155 to convert light received from the light-emitting element 155 into an electrical signal and output the result.

In an embodiment of the present disclosure, the housing 151 includes the sensing chamber 154 through which air or air containing smoke that flows in from the fire response spaces of the PE compartment 2 and the battery compartment 3 along the smoke detection pipes 134a and 134b passes, respectively, and the light-emitting element 155 and the light-receiving element 156 may be provided to face each other within the sensing chamber 154.

In an embodiment of the present disclosure, the housing 151 may have a sensing chamber through which air or air containing smoke flowing in from the PE compartment 2 passes, and a sensing chamber through which air or air containing smoke flowing in from the battery compartment 3 passes, and the two sensing chambers are provided as completely separate spaces so that light from the light-emitting element does not undergo interference.

The light-receiving element 156 is provided to output an electrical signal according to the concentration of smoke particles contained in the air passing through the sensing chamber 154 of the housing 151. The electrical signal output from the light-receiving element 156 is input to the controller 101, and the controller 101 is configured to determine whether fire occurs on the basis of the electrical signal received from the light-receiving element 156.

The controller 101 may determine the concentration of smoke particles in the air passed through the sensing chamber 154 of the housing 151 based on the electrical signal received from the smoke detector 150, and then determine whether fire occurs on the basis of the concentration of the smoke particles. The controller 101 may be configured to determine that fire occurs in a case where the concentration of smoke particles is equal to or greater than a set value.

In an embodiment of the present disclosure, in order to monitor and detect fire in two fire response spaces 2 and 3, the pair of the light-emitting element 155 and the light-receiving element 156 of the smoke detector 150 may be provided in each of two partitioned sensing chambers 154 in the housing 151.

That is, in order to independently monitor and detect fire in the PE compartment 2 and the battery compartment 3, the smoke detection sensor including the light-emitting element 155 and the light-receiving element 156 is provided in each of the partitioned sensing chambers 154 of the housing 151.

In a case where the light-emitting element 155 and the light-receiving element 156 are provided in each of the partitioned sensing chambers 154 of the housing 151, it is possible to identify the fire response space 2 or 3 where fire actually occurs from the electrical signal output from each light-receiving element 156.

Alternatively, in an embodiment of the present disclosure, a plurality of light-receiving elements 156 may be provided so that light emitted from the single light-emitting element 155 is received through the respective light-receiving elements 156, and thus, it is possible to identify the fire response space 2 or 3 where fire occurs on the basis of the electrical signals of the respective light-receiving elements 156.

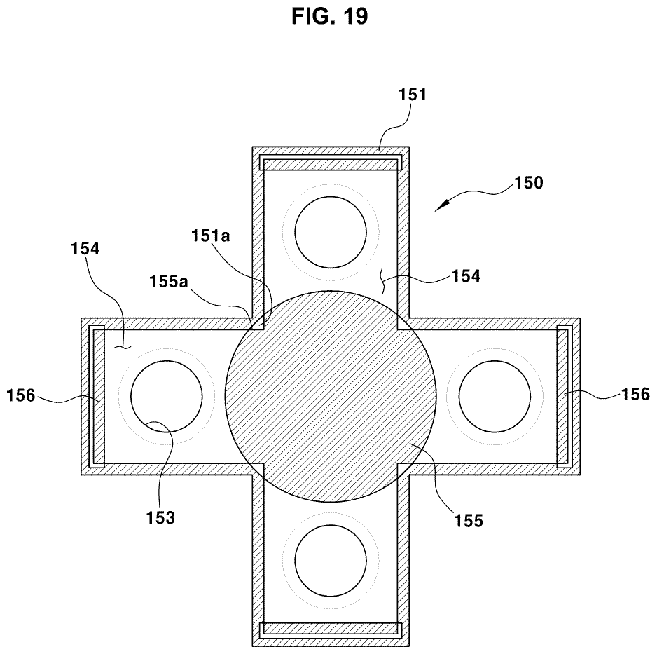

The above-described smoke detector using one light-emitting element and the plurality of light-receiving elements will be described in detail later with reference to FIGS. 18 and 19.

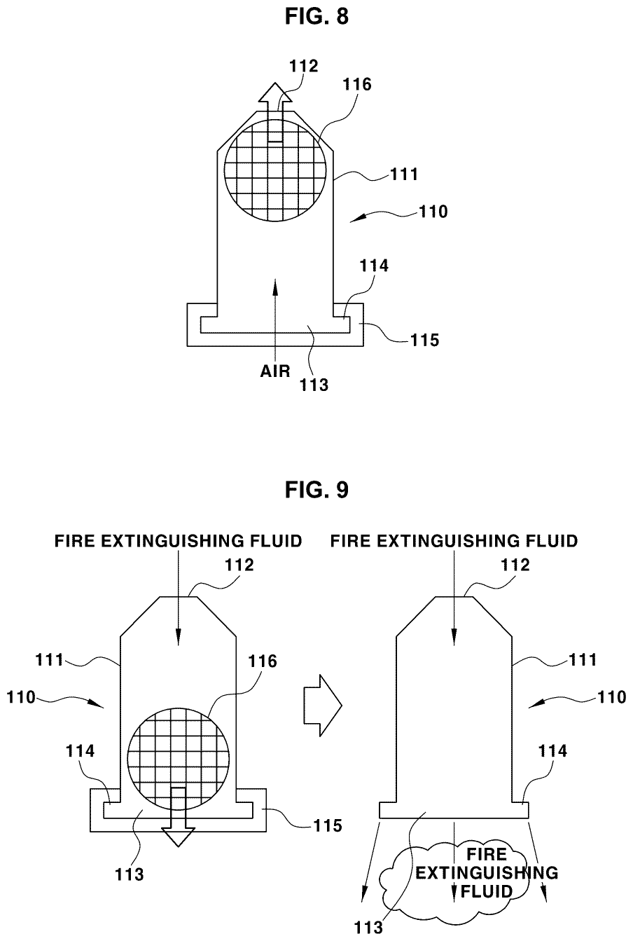

FIG. 7 is a diagram showing a configuration of a nozzle provided in a smoke suctioning and fire extinguishing fluid discharge pipe according to an embodiment of the present disclosure, FIG. 8 is a diagram showing an operating state of the nozzle in a fire detection mode according to an embodiment of the present disclosure, and FIG. 9 is a diagram showing an operating state of the nozzle when spraying a fire extinguishing fluid according to an embodiment of the present disclosure.

The nozzle 110 is fixedly provided in each of the smoke suctioning and fire extinguishing fluid discharge pipes 102a and 102b in the PE compartment 2 and the battery compartment 3, which are fire response spaces, and is used for two purposes in the present disclosure, that is, smoke suctioning and fire extinguishing fluid spraying.

In the embodiment of the present disclosure, the nozzle 110 may be equipped with filter members 115 and 116 capable of removing fine dust from air or air and smoke suctioned through the nozzle 110 and the smoke-suctioning and extinguishing fluid discharge pipes 102a and 102b in the fire detection mode.

In a case where there are no filter members 115 and 116 to remove fine dust inside the nozzle when smoke is suctioned through the nozzle 110 in the fire detection mode, the performance of the smoke detector 150 may deteriorate due to the fine dust suctioned together with the smoke, thereby lowering the fire detection performance.

On the other hand, in spraying the fire extinguishing fluid through the nozzle 110, in a case where the filter members 115 and 116 are provided inside the nozzle, the filter members may block the passage of the fire extinguishing fluid inside the nozzle or interfere with the passage of the fire extinguishing fluid, which may lower the fire extinguishing fluid spraying performance.

Therefore, in the fire detection mode where air (or air containing smoke) is normally suctioned through the nozzle, the filter members 115 and 116 should be normally provided inside the nozzle 110, and in spraying the fire extinguishing fluid, the filter members 115 and 116 should be easily separated from the nozzle 110 by the sprayed fire extinguishing fluid.

Referring to FIG. 7, the nozzle 110 may be configured to include a nozzle pipe 111 having a first end portion 112 connected to communicate with the inside of the smoke suctioning and fire extinguishing fluid discharge pipes 102a and 102b (FIG. 5) and a second end portion 113 on the opposite side disposed to face a device or component with a risk of fire within the PE compartment 2 or the battery compartment 3, which is the fire response space, a primary filter member 115 that is detachably provided to cover the second end portion 113 of the nozzle pipe 111 and primarily removes fine dust, and a secondary filter member 116 that is provided inside the nozzle pipe 111, is provided to move back and forth (up-down direction in the figure) toward the first end portion 112 and the second end portion 113, and secondarily removes fine dust.

In the nozzle 110 having the above-mentioned configuration, the first end portion 112 is a portion connected to the smoke suctioning and fire extinguishing fluid discharge pipe 102a or 102b, and is configured so that a cross-sectional area of the portion directly connected to the smoke suctioning and fire extinguishing fluid discharge pipe 102a or 102b is smaller than a cross-sectional area of the nozzle pipe 111.

For example, as shown in FIG. 7, the first end portion 112 may have a pipe shape in which the cross-sectional area gradually decreases from the nozzle pipe 111 to the portion connected to the smoke suctioning and fire extinguishing fluid discharge pipe (102a and 102b in FIG. 5).

In an embodiment of the present disclosure, the primary filter member 115 may be a mesh net (e.g., wire mesh) having a relatively large mesh size, and may be provided at the second end portion 113 of the nozzle pipe 111 so as to be detached by the fire extinguishing fluid sprayed in fire suppression.

That is, the primary filter member 115 is provided transversely at the second end portion 113, which is an outlet part of the fire extinguishing fluid of the nozzle pipe 111 and a suction part of air (or air containing smoke), and is coupled to an outer position of the nozzle pipe 111 so as to be detached from the second end portion 113 by the fire extinguishing fluid having passed through the inside of the nozzle pipe 111 for fire suppression.

Here, a flange portion 114 having an outwardly extended shape is formed on the second end portion 113 of the nozzle pipe 111, and the first filter member 115 may be fixedly combined so that an edge portion of the primary filter member 115 surrounds the flange portion 114 while being horizontally disposed on the second end portion 113 of the nozzle pipe 111.

In an embodiment of the present disclosure, the secondary filter member 116 is provided between the first end portion 112 and the second end portion 113 inside the nozzle pipe 111, and removes foreign substances such as fine dust having passed through the primary filter member 115.

In an embodiment of the present disclosure, the secondary filter member 116 may be a ball-shaped member formed of a mesh structure. The ball-shaped secondary filter element 116 is provided to move freely in the space within the nozzle pipe 111 between the first end portion 112 and the second end portion 113.

In an embodiment of the present disclosure, the secondary filter member 116 may be a ball-shaped member having a mesh size smaller than that of the primary filter member 115, and may be a member formed by bending or rolling a thin wire or the like in a ball shape.

The secondary filter element 116, similar to the primary filter element 115, is intended to maintain the performance of the smoke detector 150 by removing the foreign substances such as fine dust from the suctioned air, and also plays a role of detaching the primary filter element 115 when spraying the fire extinguishing fluid.

As shown in FIG. 8, in a case where air is suctioned through the suction pipe 144, the smoke detection pipe 134a or 134b, and the smoke suctioning and fire extinguishing fluid discharge pipe 102a or 102b by the air compressor 128, the ball-shaped secondary filter member 116 is positioned on the side of the first end portion 112 connected to the smoke suctioning and fire extinguishing fluid discharge pipe 102a or 102b by the suction pressure within the nozzle pipe 111.

Here, the ball-shaped secondary filter element 116 is positioned to block the internal passage of the nozzle pipe 111, but allows air and smoke to pass therethrough due to its mesh structure, and removes fine dust from the air being suctioned in case of fire while allowing smoke and air to pass therethrough, thereby maintaining the performance of the smoke detector 150.

On the other hand, in a case where the fire extinguishing fluid is sprayed, as shown in FIG. 9, the fire extinguishing fluid supplied through the smoke suctioning and fire extinguishing fluid discharge pipe 102a or 102b passes through the inside of the nozzle pipe 111, and strongly pushes the ball-shaped secondary filter member 116.

Here, the secondary filter member 116 causes an impact while strongly pushing the primary filter member 115 together with the fire extinguishing fluid, and thus, the primary filter member 115 is detached from the second end portion 113, which is the outlet part of the fire extinguishing fluid of the nozzle pipe 111, by the secondary filter member 116. In a case where the primary filter element 115 is detached from the nozzle pipe 111, the secondary filter element 116 also comes out of the nozzle pipe 111 and is detached.

In this way, the secondary filter member 116 removes foreign substances and also detaches the primary filter member 115 from the nozzle pipe 111. In spraying the fire extinguishing fluid, the secondary filter member 116 pushes the primary filter member 115 outward to be detached, thereby maintaining a strong extinguishing fluid spray pressure at the nozzle 110.

The configuration of the fire extinguishing system according to the embodiment of the present disclosure has been described in detail, and an operating state of the fire extinguishing system will be described.

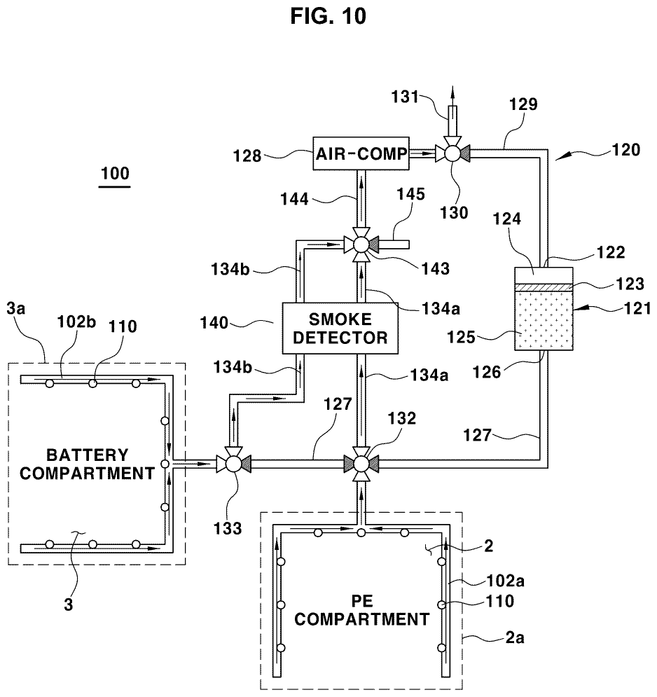

FIG. 10 is a diagram showing an operating state in the fire detection mode of the fire extinguishing system according to the embodiment of the present disclosure. In order to detect fire in normal times, the air compressor 128 is operated to apply suction pressure of the air compressor 128 to the PE compartment 2 and the battery compartment 3.

That is, the air compressor 128 is operated, and the first control valve 132 connects the smoke suctioning and fire extinguishing fluid discharge pipe 102a on the PE-compartment side and the smoke detection pipe 134a, under the control of the controller 101.

In addition, the second control valve 133 connects the smoke suctioning and fire extinguishing fluid discharge pipe 102b on the battery-compartment side and the smoke detection pipe 134b on the battery-compartment side, under the control of the controller 101. Here, the first control valve 132 and the second control valve 133 are controlled to block the fire extinguishing fluid supply pipe 127.

In addition, the intake valve 143 is controlled to block the intake port 145 while allowing the PE compartment-side smoke detection pipe 134a and the battery compartment-side smoke detection pipe 134b to communicate with the suction pipe 144 connected to the inlet of the air compressor 128. The exhaust valve 130 is controlled to open the exhaust port 131 while blocking a flow path of the air supply pipe 129 connected to the outlet of the air compressor 128.

Accordingly, in a case where the air compressor 128 is in operation, the suction pressure is applied to the PE compartment 2 and the battery compartment 3 through the suction pipe 144, the intake valve 143, the smoke detection pipes 134a and 134b, the first control valve 132, the second control valve 133, and the smoke suctioning and fire extinguishing fluid discharge pipes 102a and 102b.

In a state where the suction pressure is applied, the air inside the PE compartment 2 and the battery compartment 3 passes through the smoke suctioning and fire extinguishing fluid discharge pipe 102a or 102b, the first control valve 132, the second control valve 133, the smoke detection pipe 134a or 134b, the intake valve 143, the suction pipe 144, and the air compressor 128, and then is discharged into the atmosphere through the air supply pipe 129 and the exhaust port 131 of the exhaust valve 130.

Here, in a case where fire breaks out inside the PE compartment 2 or the battery compartment 3, smoke generated by the fire is suctioned together with air from the space where the fire broke out, and the smoke moves together with the air through the smoke suctioning and fire extinguishing fluid discharge pipe 102a or 102b and the smoke detection pipe 134a or 134b, and passes through the smoke detector 150.

Accordingly, an electrical signal of the smoke detector 150 is input to the controller 101, and the controller 101 may detect the occurrence of the fire on the basis of the electrical signal of the smoke detector 150 and identify the space where the fire occurs.

In a case where air is suctioned, the air is suctioned through each nozzle 110 of the smoke suctioning and fire extinguishing fluid discharge pipe 102a on the PE compartment-side and the smoke suctioning and fire extinguishing fluid discharge pipe 102b on the battery compartment side. In the PE compartment 2 where the fire occurs, smoke and air are suctioned together. Particularly, while air or air and smoke are suctioned through all the nozzles 110 provided in the smoke suctioning and fire extinguishing fluid discharge pipe 102a, fine dust is filtered and removed by the first filter member 115 and the second filter member 116.

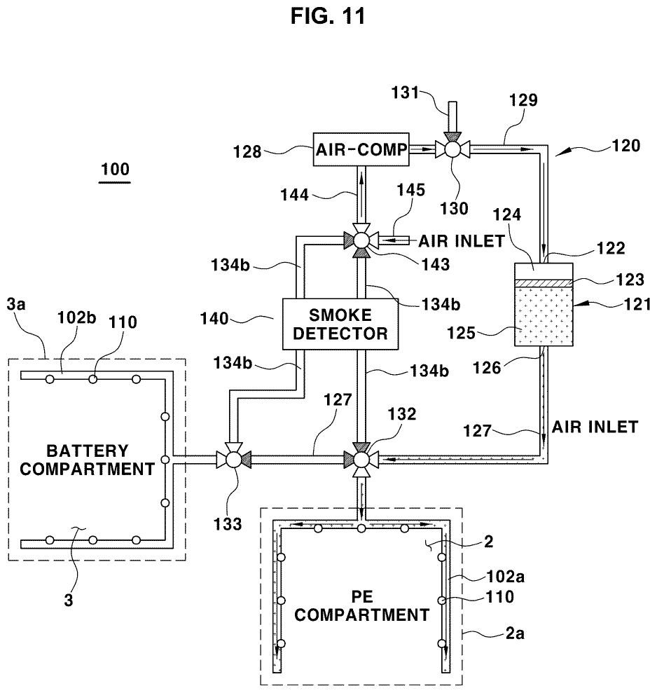

FIG. 11 is a diagram showing an operating state when fire is detected in the PE compartment of the fire extinguishing system according to the embodiment of the present disclosure. In a case where it is determined that fire occurs in the PE compartment 2, the air compressor 128 is operated under the control of the controller 101, and at this time, the intake valve 143 is controlled to open the intake port 145 while blocking the flow path of the smoke detection pipe 134a or 134b.

In addition, the exhaust valve 130 is controlled by the controller 101 to open the flow path of the air supply pipe 129 while blocking the exhaust port 131, and the first control valve 132 is controlled to connect the fire extinguishing fluid supply pipe 127 and the PE compartment-side smoke suctioning and fire extinguishing fluid discharge pipe 102a while blocking the fire extinguishing fluid supply pipe 127 connected to the smoke detection pipe 134a and the second control valve 133. Further, the second control valve 133 is controlled to block a flow path of the extinguishing fluid supply pipe 127.

As a result, the suction pressure of the air compressor 128 acts on the suction pipe 144 and the intake valve 143, thereby causing external air to flow in through the intake port 145, and the inflow air is suctioned into the air compressor 128 through the suction pipe 144 from the intake valve 143 and then discharged through the air supply pipe 129.

Here, the high-pressure compressed air discharged from the air compressor 128 may be supplied to the fire extinguishing fluid tank 121 through the exhaust valve 130 and the air supply pipe 129, and then supplied into the pressure chamber 124 of the fire extinguishing fluid tank 121 through the air inlet port 122.

Then, the pressure transfer plate 123 is pushed forward by the pressure of the compressed air supplied to the pressure chamber 124 of the fire extinguishing fluid tank 121, thereby pressurizing the fire extinguishing fluid filled in the fire extinguishing fluid chamber 125 of the fire extinguishing fluid tank 121, and the fire extinguishing fluid inside the fire extinguishing fluid chamber 125 is pressurized by the pressure transfer plate 123 and discharged through the fire extinguishing fluid outlet 126 of the fire extinguishing fluid tank 121 into the fire extinguishing fluid supply pipe 127.

Accordingly, the fire extinguishing fluid flowing through the fire extinguishing fluid supply pipe 127 moves along the PE compartment-side smoke suctioning and fire extinguishing fluid discharge pipe 102a through the first control valve 132, and is then sprayed into the PE compartment 2 through the nozzle 110, thereby suppressing fire that occurs in the PE compartment 2 by the sprayed fire extinguishing fluid.

In the smoke suctioning and fire extinguishing fluid discharge pipe 102a, the fire extinguishing fluid may be evenly sprayed into the PE compartment 2 through all the nozzles 110, and when the fire extinguishing fluid is sprayed, as described above, since the first filter member 115 and the second filter member 116 are detached from the nozzle pipe 111 by the fire extinguishing fluid, the fire extinguishing fluid may be smoothly sprayed through each nozzle 110.

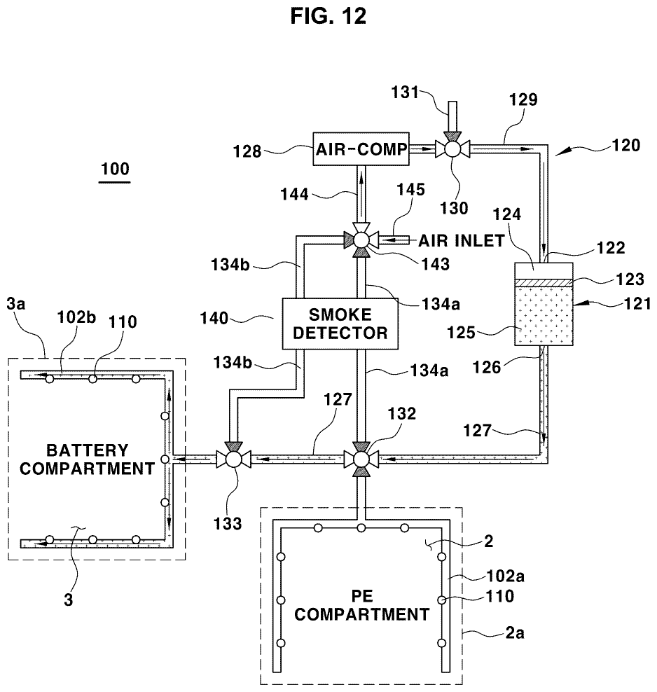

FIG. 12 is a diagram showing an operating state in a case where fire is detected in a battery compartment of the fire extinguishing system according to the embodiment of the present disclosure. In a case where it is determined that fire occurs in the battery compartment 3, the air compressor 128 is operated under the control of the controller 101, and at this time, the intake valve 143 and the exhaust valve 130 are controlled in the same manner as when fire is detected in the PE compartment.

However, the first control valve 132 is controlled by the controller 101 to block the flow paths of the smoke detection pipe 134a and the PE compartment-side smoke suctioning and fire extinguishing fluid discharge pipe 102a while opening the flow path of the fire extinguishing fluid supply pipe 127, and the second control valve 133 is controlled to block the flow path of the smoke detection pipe 134b while allowing the fire extinguishing fluid supply pipe 127 and the battery compartment-side smoke suctioning and fire extinguishing fluid discharge pipe 102b to communicate with each other.

As a result, the suction pressure of the air compressor 128 acts on the suction pipe 144 and the intake valve 143, thereby causing external air to flow in through the intake port 145, and the inflow air is suctioned into the air compressor 128 through the suction pipe 144 from the intake valve 143 and then discharged through the air supply pipe 129.

Here, the high-pressure compressed air discharged from the air compressor 128 may be supplied to the fire extinguishing fluid tank 121 through the exhaust valve 130 and the air supply pipe 129, and then supplied into the pressure chamber 124 of the fire extinguishing fluid tank 121 through the air inlet port 122.

Then, the pressure transfer plate 123 is pushed forward by the pressure of the compressed air supplied to the pressure chamber 124 of the fire extinguishing fluid tank 121, thereby pressurizing the fire extinguishing fluid filled in the fire extinguishing fluid chamber 125 of the fire extinguishing fluid tank 121, and the fire extinguishing fluid inside the fire extinguishing fluid tank 121 is pressurized by the pressure transfer plate 123 and discharged through the fire extinguishing fluid outlet 126 of the fire extinguishing fluid tank 121 to the fire extinguishing fluid supply pipe 127.

Accordingly, the fire extinguishing fluid flowing through the fire extinguishing fluid supply pipe 127 passes through the first control valve 132, moves to the battery compartment-side smoke suctioning and fire extinguishing fluid discharge pipe 102b through the second control valve 133, and then is sprayed into the battery compartment 3 through the nozzle 110 from the battery compartment-side smoke suctioning and fire extinguishing fluid discharge pipe 102b. Accordingly, it is possible to extinguish the fire that occurs in the battery compartment 3 by the sprayed fire extinguishing fluid.

In the smoke suctioning and fire extinguishing fluid discharge pipe 102b, the fire extinguishing fluid may be evenly sprayed into the battery compartment 3 through the nozzles 110, and when the fire extinguishing fluid is sprayed, as described above, the first filter member 115 and the second filter member 116 are detached from the nozzle pipe 111 by the fire extinguishing fluid, so that the fire extinguishing fluid can be smoothly sprayed through each nozzle 110.

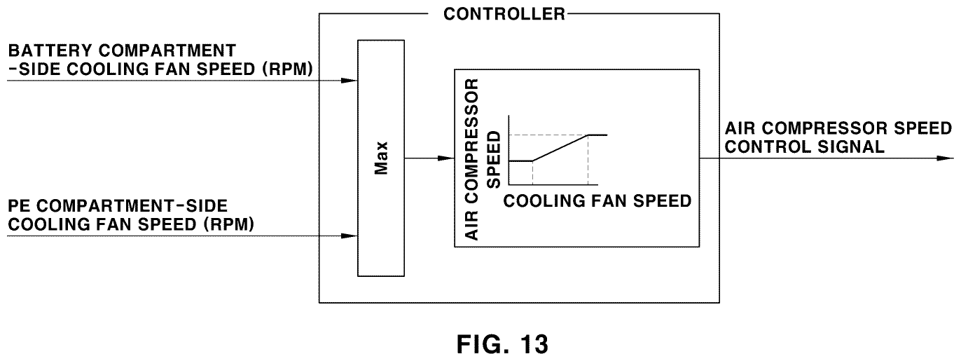

FIG. 13 is a diagram for illustrating a method of controlling an air compressor by a controller of the fire extinguishing system according to the embodiment of the present disclosure.

In the fire detection mode, the speed (RPM) of the air compressor 128 is controlled to vary on the basis of the speed (RPM) of the PE compartment-side cooling fan (electric fan) and the speed (RPM) of the battery compartment-side cooling fan (electric fan).

That is, the controller 101 determines the speed of the air compressor corresponding to the larger value between the speed of the PE compartment-side cooling fan and the speed of the battery compartment-side cooling fan from setting data such as a map, and then controls the speed of the air compressor 128 at the determined speed.

Here, the controller 101 may pre-store the setting data that defines the correlation between the speed of the cooling fan and the speed of the air compressor, and a speed value of the air compressor corresponding to the speed of the cooling fan is preset in the setting data. In the setting data, the speed (target speed) of the air compressor is set to a larger value as the speed of the cooling fan becomes larger.

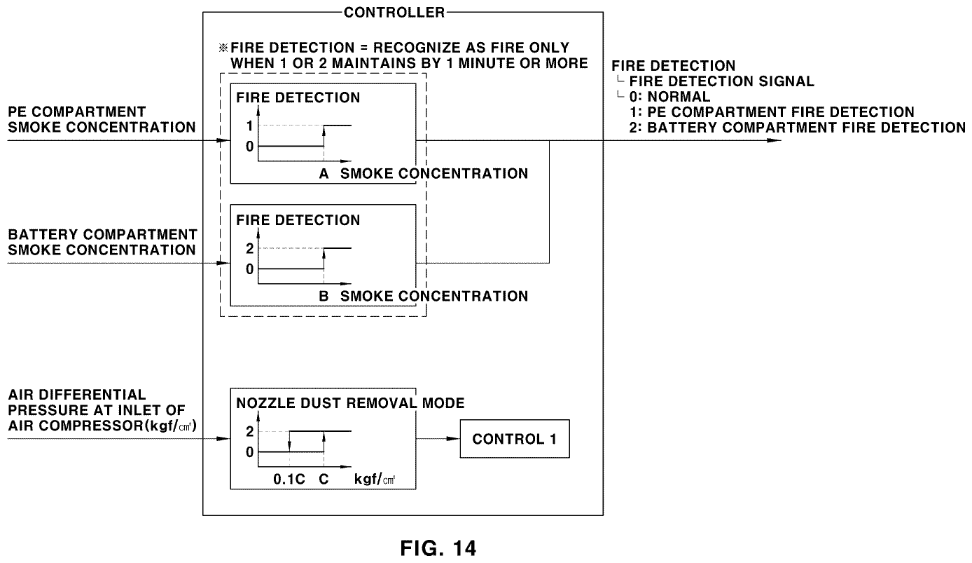

FIG. 14 is a diagram for illustrating a method of detecting fire by the controller of the fire extinguishing system according to the embodiment of the present disclosure. In the fire detection mode shown in FIG. 10, in a case where it is determined that fire occurs from an electrical signal of the smoke detector 150, the controller 101 generates a fire detection signal according to the determination result.

In the smoke detector 150, an electrical signal output from the smoke detection sensor on the PE compartment side is a signal corresponding to the concentration of smoke in the air suctioned in the PE compartment 2, and an electrical signal output from the smoke detection sensor on the battery compartment side is a signal corresponding to the concentration of smoke in the air suctioned in the battery compartment 3. The electrical signals output from the PE compartment-side smoke detection sensor and the battery compartment-side smoke detection sensor are signals indicating the concentrations of smoke flowing out of the respective fire response spaces.

The controller 101 determines the PE compartment-side smoke concentration and the battery compartment-side smoke concentration from the electrical signals output from the respective smoke detection sensors, compares the PE compartment-side smoke concentration and the battery compartment-side smoke concentration with preset reference values A and B, and determines that fire occurs in the corresponding space in a case where either the PE compartment-side smoke concentration or the battery compartment-side smoke concentration is equal to or higher than each reference value for a preset period of time or longer.

According to the embodiment of FIG. 14, in a case where the PE compartment-side smoke concentration is maintained at the value A or higher, which is the reference value, for a preset time (e.g., 1 minute), the controller 101 determines that there is fire in the PE compartment 2, and generates a fire detection signal (signal value “1”) indicating that fire occurs in the PE compartment 2.

In a case where the battery compartment-side smoke concentration remains at the reference value B or higher for a preset period of time, the controller 101 determines that there is fire in the battery compartment 3, and generates a fire detection signal (signal value “2”) indicating that fire has occurred in the battery compartment 3. Here, in a case where a normal state with no fire is maintained, the controller 101 may generate a signal (signal value “0”) indicating the normal state.

In addition, the air compressor 128 is provided with a standard pressure sensor that detects the pressure at the inlet (suction side) thereof, that is, an air differential pressure, and the pressure sensor is provided to transmit a signal to the controller 101.

The electrical signal output from the pressure sensor is a signal corresponding to the air pressure applied to the inlet of the air compressor 128, and the controller 101 receives the electrical signal output from the pressure sensor.

In the present disclosure, the controller 101 may be set to periodically perform a nozzle dust removal mode. In the nozzle dust removal mode, the controller 101 determines, in a state where the air compressor 128 is operated to apply suction pressure to each fire response space, whether a certain level of dust is accumulated in the nozzle 110 of the smoke suctioning and fire extinguishing fluid discharge pipe 102a or 102b provided in each fire response space.

Here, the controller 101 determines the air differential pressure, which is the pressure at the inlet of the air compressor 128, on the basis of the electrical signal input from the pressure sensor while the air compressor is operating. In a case where the air differential pressure detected by the pressure sensor is equal to or higher than a first set pressure (an upper threshold “C”), it is determined that a certain level of dust has accumulated in the nozzle 110 of the smoke suctioning and fire extinguishing fluid discharge pipe 102a or 102b provided in each fire response space.

In a case where it is determined that the certain level of dust has accumulated, the controller 101 performs control for nozzle reverse cleaning (“control 1” in FIG. 14). To this end, the controller 101 operates the air compressor 128 in the reverse direction at a set speed (e.g., 3,000 RPM), and controls the opening states of the first control valve 132, the second control valve 133, the intake valve 143, and the exhaust valve 130 in the same manner as in the fire detection mode.

As a result, the high-pressure compressed air discharged in the reverse direction from the inlet of the air compressor 128 moves in the reverse direction to that in fire detection and is supplied to the PE compartment-side smoke suctioning and fire extinguishing fluid discharge pipe 102a and the battery compartment-side smoke suctioning and fire extinguishing fluid discharge pipe 102b.

Thus, reverse cleaning may be performed to remove the dust accumulated in each nozzle 110 by discharging the high-pressure compressed air through each nozzle 110 from the smoke suctioning and fire extinguishing fluid discharge pipe 102a or 102b in each fire response space of the PE compartment 2 and the battery compartment 3.

During the reverse cleaning, the operation of the air compressor 128 is maintained until the air differential pressure at the inlet of the air compressor detected by the pressure sensor reaches a second set pressure (lower threshold “0.1C”), and in a case where the second set pressure is reached, the operation of the air compressor 128 is stopped.

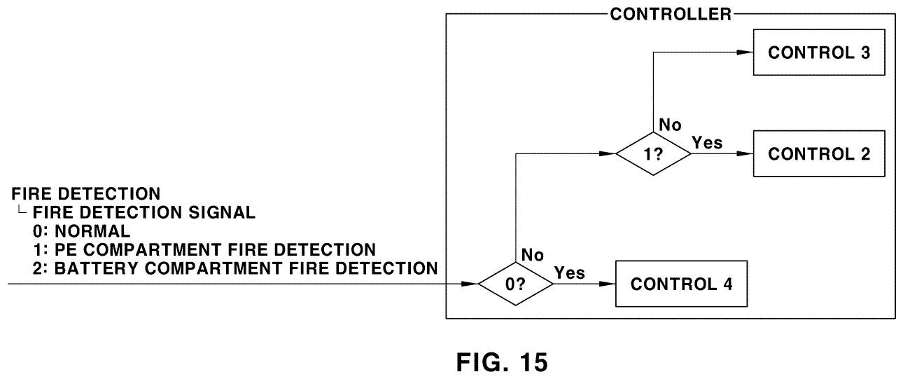

FIG. 15 is a diagram for illustrating a control state in fire detection of the fire extinguishing system according to the embodiment of the present disclosure.

In a case where it is determined that fire occurs in the PE compartment 2, that is, in a case where the controller 101 generates a fire detection signal with a signal value of “1”, the controller 101 controls the opening states of the first control valve 132, the second control valve 133, the intake valve 143, and the exhaust valve 130 as shown in FIG. 11, and operates the air compressor 128 (“control 2” in FIG. 15). Here, the air compressor 128 may be operated at the maximum speed.

This allows the fire extinguishing fluid filled in the fire extinguishing fluid tank 121 to be supplied to the PE compartment-side smoke suctioning and fire extinguishing fluid discharge pipe 102a, and thus, allows the fire extinguishing fluid to be sprayed into the PE compartment 2 through each nozzle 110 from the PE compartment-side smoke suctioning and fire extinguishing fluid discharge pipe 102a, thereby extinguishing the fire in the PE compartment.

Further, in a case where the controller 101 generates the fire detection signal “1”, the controller 101 operates a warning device (not shown) of the vehicle 1 according to the fire detection signal to notify a driver of the fire occurrence and the status of fire extinguishing fluid spraying in the PE compartment 2, and also wirelessly transmits a fire occurrence signal to a nearby fire station for dispatch of a fire truck.

In a case where the controller 101 determines that fire occurs in the battery compartment 3, that is, in a case where the controller 101 generates a fire detection signal with a signal value of “2”, as shown in FIG. 12, the controller 101 controls the opening states of the first control valve 132, the second control valve 133, the intake valve 143, and the exhaust valve 130, and operates the air compressor 128 (“control 3” in FIG. 15). Here, the air compressor 128 may be operated at the maximum speed.

This allows the fire extinguishing fluid filled in the fire extinguishing fluid tank 121 to be supplied to the smoke suctioning and fire extinguishing fluid discharge pipe 102b of the battery compartment 3, and thus, allows the fire extinguishing fluid to be sprayed into the battery compartment 3 through each nozzle 110 from the battery compartment-side smoke suctioning and fire extinguishing fluid discharge pipe 102b, thereby extinguishing the fire in the battery compartment.

Further, in a case where the controller 101 generates the fire detection signal “2”, the controller 101 operates the warning device of the vehicle 1 according to the fire detection signal to notify the driver of the fire occurrence and the status of fire extinguishing fluid spraying in the battery compartment 3, and also wirelessly transmits a fire occurrence signal to a nearby fire station for dispatch of a fire truck.

In a case where the fire response space is in a normal state where no fire occurs, the controller 101 controls the fire extinguishing system 100 of the present disclosure to the normal fire detection mode described with reference to FIG. 10 (“control 4” in FIG. 15).

In the embodiment of FIG. 5, the fire occurrence is monitored and detected using the smoke detector 150 in two areas of the PE compartment 2 and the battery compartment 3 as the fire response spaces.

As described above, in the embodiment of FIG. 5, the smoke detector 150 is used to monitor and detect the fire occurrence in the fire response spaces (fire monitoring zones) of the PE compartment 2 and the battery compartment 3 in the fire detection mode, and the fire extinguishing fluid is supplied only to a zone where fire actually occurs among the two zones of the PE compartment 2 and the battery compartment 3, thereby extinguishing the fire.

In the embodiment of FIG. 5, the smoke detector 150 may be a multi-zone smoke detector, and in this case, may monitor fire occurrence simultaneously in two zones, that is, the PE compartment 2 and the battery compartment 3.

The configuration of the fire extinguishing system shown in FIG. 5 is exemplary, and the present disclosure is not limited thereto. Various modifications or variations may be made therefrom. For example, the number of fire response spaces, such as the PE compartment 2 and the battery compartment 3 in the vehicle, i.e. the number of fire monitoring zones, may be changed, and the configuration of the fire extinguishing fluid supply pipe 127 or the smoke detection pipes 134a and 134b may be changed in consideration of the number of fire monitoring zones.

Specifically, the number of fire monitoring zones in the vehicle may be three or more, and the configuration of the fire extinguishing fluid supply pipe 127 and the smoke detection pipes 134a and 134b may be changed in consideration of the increased number of fire monitoring zones. Here, the smoke detector 150 may be configured to simultaneously monitor fire occurrence in all zones in consideration of the number of fire monitoring zones in the vehicle.

The smoke detector 150 may be an individual smoke detector that monitors each zone, but is preferably a multi-zone smoke detector that has an integrated configuration and can simultaneously monitor fire occurrence for all fire monitoring zones in the vehicle.

Hereinafter, the multi-zone smoke detector applicable to the present disclosure and a fire extinguishing system capable of monitoring and detecting fire occurrence and suppressing the fire in a greater number of fire response spaces or fire monitoring zones using the same will be described.

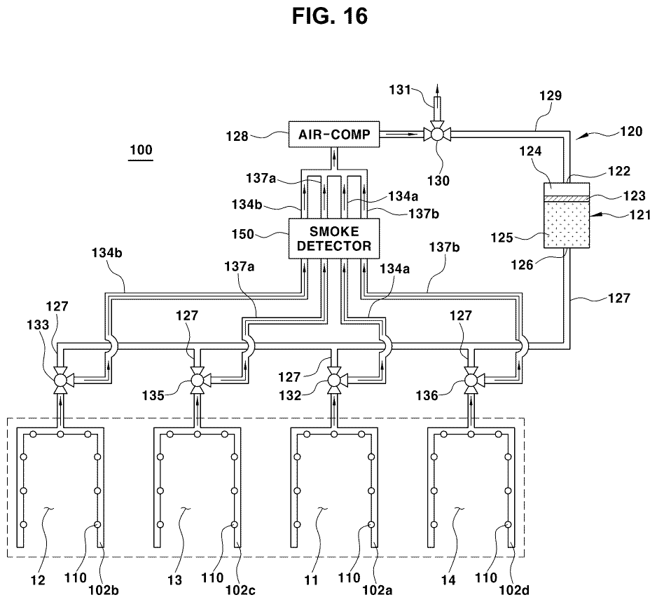

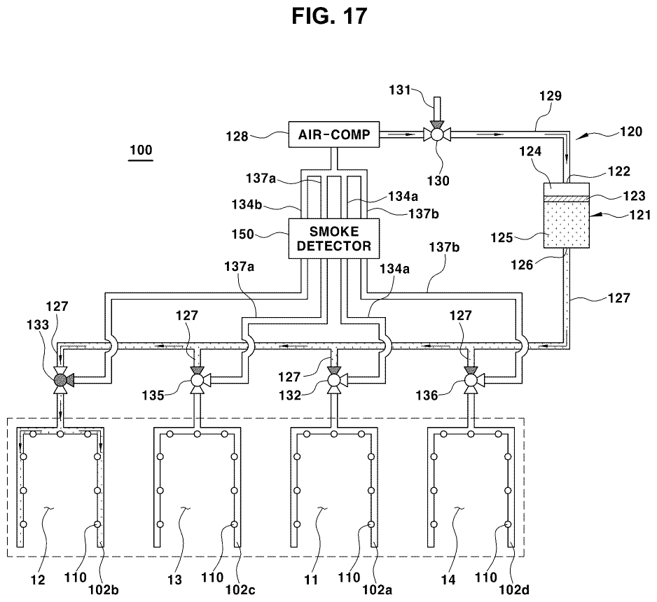

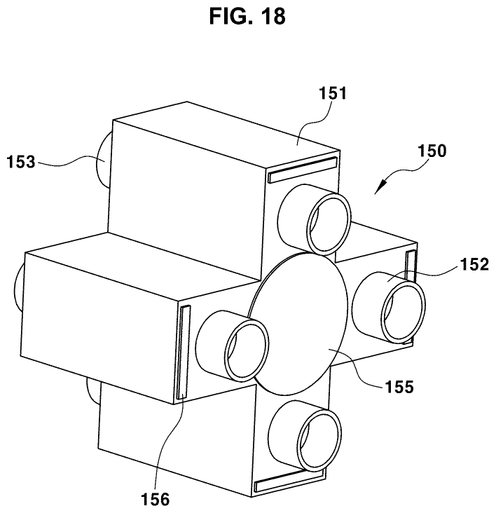

FIG. 16 is a diagram showing a configuration of a fire extinguishing system using a multi-zone smoke detector according to another embodiment of the present disclosure, and FIG. 17 is a diagram showing an operating state of the fire extinguishing system shown in FIG. 16.

FIG. 18 is a perspective view showing the multi-zone smoke detector according to the embodiment of the present disclosure, and FIG. 19 is a cross-sectional view showing a configuration of the multi-zone smoke detector according to the embodiment of the present disclosure.

In the embodiment of FIG. 16, the number of fire response spaces (fire monitoring zones 11 to 14) is four. In the embodiment of FIG. 16, since the smoke suctioning and fire extinguishing fluid discharge pipes 102a, 102b, 102c and 102d provided in the respective zones 11 to 14 and the nozzles 110 provided in the smoke suctioning and fire extinguishing fluid discharge pipes are similar to the embodiment of FIG. 5 in terms of configurations, functions, operating states, etc., detailed description thereof will be omitted.

The fire extinguishing system 100 according to the embodiment of FIG. 16 may be applied to an electric vehicle or a fuel cell vehicle. When applied to the fuel cell vehicle, the plurality of fire monitoring zones may include one or more of a PE compartment where electrical components (PE components) are provided, a battery compartment where batteries are provided, and a stack compartment where fuel cell stacks are provided.

The four fire response spaces (fire monitoring zones) shown in the embodiment of FIG. 16 may be a PE compartment 11, battery compartments 12 and 13, and a stack compartment 14 (that is, one PE compartment, two battery compartments, and one stack compartment).

Since the fire extinguishing fluid supply device 120, the air compressor 128, and the exhaust valve 130 provided at a location where the exhaust port 131 branches off from the air supply pipe 129 are similar to the embodiment of FIG. 5, detailed description thereof will be omitted.

In the embodiment of FIG. 16, the fire extinguishing fluid supply pipe 127 is connected to the fire extinguishing fluid outlet 126 of the fire extinguishing fluid tank 121, and the fire extinguishing fluid supply pipe 127 branches out to the respective fire response space 11 to 14. In addition, the branched extinguishing fluid supply pipes 127 are connected to the smoke suctioning and fire extinguishing fluid discharge pipes 102a, 102b, 102c and 102d provided in the fire response spaces 11 to 14 via the control valves 132, 133, 135 and 136.

Further, the smoke suctioning and fire extinguishing fluid discharge pipes 102a, 102b, 102c and 102d of the fire response spaces 11 to 14 are connected to the respective smoke detection pipes 134a, 134b, 137a and 137b via the control valves 132, 133, 135 and 136, and the respective smoke detection pipes 134a, 134b, 137a and 137b are connected to a multi-zone monitoring smoke detector 150.

Referring to FIG. 16, in a case where the two fire response spaces 12 and 13 on the left side of the diagram are battery compartments, the fire response space 11 on the right side is a PE compartment, and the rightmost fire response space 14 is a stack compartment, two branched fire extinguishing fluid supply pipes 127, the battery compartment-side smoke suctioning and fire extinguishing fluid discharge pipes 102b and 102c, and the battery compartment-side smoke detection pipes 134b and 137a are respectively connected via the second control valve 133 and the third control valve 135.

Likewise, another branched extinguishing fluid supply pipe 127, the PE compartment-side smoke suctioning and fire extinguishing fluid discharge pipe 102a, and the PE compartment-side smoke detection pipe 134a are connected via the first control valve 132, and the remaining branched extinguishing fluid supply pipe 127, the stack compartment-side smoke suctioning and fire extinguishing fluid discharge pipe 102d, and the stack compartment-side smoke detection pipe 137b are connected via the fourth control valve 136.

Each of the control valves 132, 133, 135 and 136 may be an electronic valve whose opening state is controlled by a controller (reference sign “101” in FIG. 2), and specifically, may be an electronic 3-way valve provided to connect three pipes.

The block diagram of FIG. 2 shows the configuration according to the embodiment of FIG. 5, and only the first control valve 132 and the second control valve 133 are shown in FIG. 2. However, in comparing the configuration according to the embodiment of FIG. 16 with the block diagram of FIG. 2, the third control valve 135 and the fourth control valve 136 controlled by the controller 101 are additionally shown in the configuration of FIG. 2.

In addition, the smoke detection pipes 134a, 134b, 137a and 137b connected from the respective control valves 132, 133, 135 and 136 are each connected to a corresponding inlet port 152 (see FIGS. 18 and 19) provided in the housing 151 (see FIGS. 18 and 19) of the smoke detector 150, and the housing 151 of the smoke detector 150 is provided with an outlet port 153 (see FIGS. 18 and 19) through which air or air containing smoke flowing in through each inlet port 152 is discharged, and each of the smoke detection pipes 134a, 134b, 137a and 137b is connected to each outlet port 153.

The smoke detection pipes 134a, 134b, 137a and 137b connected to the outlet ports 153 are combined and connected to the suction pipe 144 to then be connected to the air compressor 128. In addition, in the embodiment of FIG. 16, an intake port (not shown) may be provided in the air compressor 128, and an intake valve (not shown) whose opening and closing operation is controlled by the controller 101 may be provided in the intake port.

FIG. 16 shows an example of a state of a fire detection mode. Normally, the fire extinguishing system is operated in the fire detection mode to monitor and detect fire occurrence in each of the fire response spaces 11, 12, 13 and 14.

In the fire detection mode, the operation of the exhaust valve 130, which is an electronic multi-way valve, is controlled by the controller 101 to open the exhaust port 131 and simultaneously block the air supply pipe 129 connected to the fire extinguishing fluid tank 121.

Further, the operations of the control valves 132, 133, 135 and 136, which are electronic multi-way valves, are controlled by the controller 101 that the fire extinguishing fluid supply pipe 127 is blocked, and simultaneously, the smoke detection pipes 134a, 134b, 137a and 137b and the smoke suction and fire extinguishing fluid discharge pipes 102a, 102b, 102c and 102d are opened for communication with each other.

Here, in a case where the air compressor 128 is operated by the controller 101, the suction pressure of the air compressor 128 is applied to each of the fire response spaces 11 to 14. While the suction pressure is applied, the air inside each fire response space passes through the smoke suctioning and fire extinguishing fluid discharge pipes 102a, 102b, 102c and 102d, the control valves 132, 133, 135 and 136, the smoke detection pipes 134a, 134b, 137a and 137b, the smoke detector 150, the suction pipe 144, and the air compressor 128, and is then discharged to the atmosphere through the air supply pipe 129 and the exhaust port 131 of the exhaust valve 130.

Here, in a case where fire breaks out inside one of the fire response spaces 11, 12, 13 and 14, smoke generated during the fire flows in together with air from the space where the fire breaks out, and this smoke moves together with air through the smoke suctioning and fire extinguishing fluid discharge pipes 102a, 102b, 102c and 102d, and the smoke detection pipes 134a, 134b, 137a and 137b and passes through the smoke detector 150.

Accordingly, an electrical signal of the smoke detector 150 is input to the controller 101, and the controller 101 may detect the occurrence of the fire on the basis of the electrical signal of the smoke detector 150 and identify the space where the fire occurs.

FIG. 17 shows an operating state of a fire suppression mode in a case where fire breaks out in one of the plurality of fire response spaces (fire monitoring zones, 11, 12, 13 and 14), for example, in a case where fire breaks out in one battery compartment 12 on the left side of the diagram.

The air compressor 128 is operated under the control of the controller 101, and at this time, an intake valve (not shown) is controlled by the controller 101 to open the intake port. Further, the operation of the exhaust valve 130 is controlled by the controller 101 to open the air supply pipe 129 connected to the fire extinguishing fluid tank 121 while closing the exhaust port 131.

In addition, the opening state of the second control valve 133 is controlled by the controller 101 to allow communication between the fire extinguishing fluid supply pipe 127 and the battery compartment-side smoke suctioning and fire extinguishing fluid discharge pipe 102b while blocking the smoke detection pipes 134a, 134b, 137a and 137b. Here, the first control valve 132, third control valve 135, and fourth control valve 136 maintain a state of blocking the fire extinguishing fluid supply pipe 127.

In this way, high-pressure compressed air that is suctioned in through the intake port and then discharged from the air compressor 128 may be supplied to the fire extinguishing fluid tank 121 through the air supply pipe 129, and then supplied into the pressure chamber 124 of the fire extinguishing fluid tank 121 through the air inlet port 122.

Then, the pressure transfer plate 123 is pushed forward by the pressure of the compressed air supplied to the pressure chamber 124 of the fire extinguishing fluid tank 121 to thereby pressurize the fire extinguishing fluid stored in the fire extinguishing fluid chamber 125 of the fire extinguishing fluid tank 121. The fire extinguishing fluid inside the fire extinguishing fluid chamber 125 pressurized by the pressure transfer plate 123 is discharged to the fire extinguishing fluid supply pipe 127 through the fire extinguishing fluid outlet 126 of the fire extinguishing fluid tank 121.

As a result, the fire extinguishing fluid passed through the fire extinguishing fluid supply pipe 127 moves to the battery compartment-side smoke suctioning and fire extinguishing fluid discharge pipe 102b at the second control valve 133, and then is sprayed into the battery compartment 12 through the nozzle 110. Accordingly, it is possible to extinguish the fire that occurs in the battery compartment 12 by the sprayed fire extinguishing fluid.

The fire extinguishing system 100 according to the embodiment of the present disclosure may be configured to enable fire monitoring and detection for the plurality of fire response spaces 11, 12, 13 and 14 with one smoke detector 150. To this end, the integrated multi-zone smoke detector 150 may be used.

Referring to FIGS. 18 and 19, the multi-zone smoke detector 150 includes the housing 151, the light-emitting element 155 provided in the housing 151, and the light-receiving elements 156 provided in the housing 151 so as to face the light-emitting element 155.

The housing 151 includes the sensing chamber 154 provided for each of the fire response spaces 11, 12, 13 and 14 and arranged along a circumference of the light-emitting element 155 so that air or air containing smoke flowing in from the fire response spaces 11, 12, 13 and 14 can pass therethrough.

The light emitting element 155 may be provided at the center of an internal space of the housing 151, and the sensing chamber 154 may be a plurality of sealed spaces provided by dividing the internal space of the housing 151.

The light-emitting element 155 may be a cylindrical element that is provided in a cylindrical shape and can evenly emit light in all directions over the entire circumference. In addition, the plurality of light-receiving elements 156 are arranged centered around the light-emitting element 155, and each light-receiving element is provided in each sensing chamber 154 in the internal space of the housing 151.

Each of the light-receiving elements 156 is provided to face the light-emitting element 155 within the internal space of the housing 151, particularly, within each partitioned sensing chamber 154, so as to receive light emitted from the light-emitting element 155.

In an embodiment of the present disclosure, as in the embodiment of FIG. 16, four sensing chambers 154 may be provided in the housing 151 to enable fire monitoring and detection for four fire response spaces (fire monitoring zones, 11, 12, 13 and 14), and one light-emitting element 155 and four light-receiving elements 156 may be provided.

In this configuration, the housing 151 may be provided in a “+” shape in which the sensing chambers 154 and the light-receiving elements 156 are arranged on the upper, lower, left, and right sides of the light-emitting element 155 when viewed from the front, as shown in FIGS. 18 and 19.

That is, in the “□” shaped housing 151, the light emitting element 155 is placed at the center of the internal space, and each sensing chamber 154 and each light receiving element 156 are placed at each of the four locations centering around the light emitting element 155. The light receiving elements 156 are all provided at positions spaced apart from the light emitting element 155 by the same distance within each sensing chamber 154.

The plurality of sensing chambers 154 and the plurality of light-receiving elements 156 may be arranged at equal intervals along a circumferential direction centered on the light-emitting element 155, and the number of sensing chambers 154 and light-receiving elements 156 may be changed according to the number of fire response spaces (fire monitoring zones, 11, 12, 13 and 14).

That is, the embodiment of FIGS. 18 and 19 exemplifies the smoke detector 150 for fire monitoring and detection for four fire response spaces, but in a case where the number of fire response spaces (fire monitoring zones) is five or six, five or six sensing chambers 154 and light-receiving elements 156 may also be arranged centering around the light-emitting element 155.

In this way, to enable individual fire monitoring and detection for each of the fire response spaces 11, 12, 13 and 14, the sensing chambers 154 and the light-receiving elements 156 are provided in equal number to the fire response spaces.

Accordingly, the multi-zone smoke detector 150 according to the embodiment of the present disclosure has the same number of sensing chambers 154 and light-receiving elements 156 as the number of fire response spaces 11, 12, 13 and 14 that are fire monitoring and detection targets, but only one light-emitting element 155 may be provided in one housing 151.

In this way, the single integrated smoke detector 150, particularly, the multi-zone smoke detector 150 capable of individual fire monitoring and detection for the plurality of fire response spaces 11, 12, 13 and 14 may be provided.

As shown in FIG. 19, the light-receiving elements 156 may be provided in a plate shape of a predetermined thickness, and may be provided on the inner surface of each sensing chamber 154 at a position opposite to the light-emitting element 155 located at the center of the internal space of the housing 151.

The housing 151 is provided to block external light, and may be designed to block light between the sensing chambers 154 so as not to affect fire detection performance in other adjacent sensing chambers 154.

To this end, as shown in FIG. 19, a plurality of grooves 155a may be formed on the circumference of the cylindrical light-emitting element 155, into which a boundary portion 151a between the sensing chambers 154 of the housing 151 may be fitted.

Each of the grooves 155a may be formed to extend in a lengthwise direction (axial direction) of the light-emitting element 155 from the circumference thereof. In addition, the plurality of grooves 155a are formed to be spaced apart from each other at a preset interval, for example, at equal intervals in the circumferential direction on the circumference of the light-emitting element 155.

In this way, when assembling the light-emitting element 155 into the center of the internal space of the “□” shaped housing 151, the cylindrical light-emitting element 155 may be assembled into the internal space of the housing 151 while fitting each boundary portion 151a between the sensing chambers 154 into each groove 155a, as shown in FIG. 19.

For example, in a case where the cylindrical light-emitting element 155 is inserted into the internal space of the housing 151 and slid in the axial direction so that each boundary portion 151a between the sensing chambers 154 is fitted into each groove 155a, it is possible to block light between the sensing chambers 154 with the boundary portion 151a fitted in each groove 155a as shown in FIG. 19.

Further, the housing 151 may be made of a material or structure capable of blocking light, and for example, may be molded from a plastic material capable of blocking light. Here, light-blocking pigments or additives may be added to the plastic material.

In addition, the inlet port 152 is provided at the front of each sensing chamber 154 in the housing 151 of the multi-zone smoke detector 150, and the outlet port 153 is provided at the rear of each sensing chamber 154.

The smoke detection pipes 134a, 134b, 137a and 137b extended from the control valves 132, 133, 135 and 136 in the fire response spaces 11, 12, 13 and 14 are connected to the corresponding inlet ports 152 of the sensing chambers 154.

In addition, the smoke detection pipes 134a, 134b, 137a and 137b that are connected to the suction pipe 144 are connected to the outlet port 153. In connecting the smoke detection pipes 134a, 134b, 137a and 137b to the inlet port 152 and the outlet port 153, a known quick connector may be used.

In this way, in the present disclosure, the single smoke detector 150 may be used to monitor and detect fire occurrence in a plurality of fire response spaces, and in particular, one light-emitting element 155 may be used to configure the smoke detector 150. Thus, it is possible to reduce the number of parts, simplify the configuration, and reduce the cost.

The multi-zone smoke detector 150 according to the embodiment of the present disclosure is an integrated smoke detector 150 capable of detecting the concentration of smoke generated in a plurality of zones using one light-emitting element 155 and the plurality of light-receiving elements 156, but the concentration detection using the light-emitting element 155 and the light-receiving elements 156 and the operating principle thereof are not different from the operating principle of the existing photoelectric smoke detector 150.

However, in the multi-zone smoke detector 150, an electrical signal value of each light-receiving element 156 indicating the concentration of smoke in the air, i.e., a current measurement value or a voltage measurement value of each light-receiving element 156, may vary depending on the speed of air passing through each sensing chamber 154, and in this case, a detection error may occur.

In this case, the smoke concentration may be obtained using a value obtained by reflecting an additional variable in the electrical signal of the light receiving element 156 in the controller 101. To this end, the controller 101 may determine the smoke concentration from setting data that uses the electrical signal value of the light receiving element 156 and the variable as inputs.

Here, the setting data may be obtained using information acquired through processes such as a preliminary tests and evaluations performed during a vehicle development process, and may include a formula or a map for defining the correlation between the electrical signal value of the light-receiving element 156 and the variable, and the smoke concentration.

For example, the variables may be a rotation speed (RPM) of the air compressor 128 and a rotation speed (RPM) of the cooling fan provided in the corresponding fire response space, and the controller 101 may use the rotation speeds as additional variables or correction variables to determine the concentration of smoke in the air discharged from the corresponding area from the electrical signal of the light-receiving element 156.

The setting data such as a formula or map may be input in advance into the controller 101, and then, may be used by the controller 101 to determine the concentration of smoke in the air passing through the corresponding sensing chamber 154 from the electrical signal of each light-receiving element 156.

In this way, in the present disclosure, the multi-zone smoke detector 150 provided to detect smoke in the air flowing in through the nozzle 110 and the smoke suctioning and fire extinguishing fluid discharge pipes 102a, 102b, 102c and 102d from the plurality of fire monitoring zones 11, 12, 13 and 14, respectively.

The multi-zone smoke detector 150 has a configuration in which the light-receiving elements for the fire monitoring zones and one light-emitting element are combined, as described above, and outputs an electrical signal corresponding to the smoke concentration in air flowing in from each of the plurality of fire monitoring zones 11, 12, 13 and 14.

In utilizing the multi-zone smoke detector 150, the controller 101 may determine the smoke concentration value in the air flowing in from each of the plurality of fire monitoring zones on the basis of the electrical signal of the multi-zone smoke detector 150, the speed (RPM) of the air compressor 128, and the speed (RPM) of the cooling fan (e.g., the cooling fan of the battery compartment, see reference numeral “9” in FIG. 4) provided in the corresponding fire monitoring zone.

According to the fire extinguishing system for the vehicle according to the present disclosure, it is possible to accurately detect a fire occurrence in the vehicle, and quickly and automatically extinguish the fire.

In particular, according to the multi-zone smoke detector of the present disclosure, it is possible to simultaneously monitor fire occurrence in a plurality of zones provided in the vehicle, and accurately distinguish and determine a zone where the fire occurs among the plurality of zones.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. A multi-zone smoke detector comprising:
a housing connected to a smoke detection pipe and configured to allow air or air containing smoke flowing in from a plurality of fire monitoring zones to pass through a plurality of the smoke detection pipes;
a light-emitting element positioned in the housing; and
a plurality of light-receiving elements provided in the housing facing the light-emitting element and configured to convert light received from the light-emitting element into an electrical signal, and to output the electrical signal;
wherein the housing comprises a plurality of sensing chambers, each of the plurality of sensing chambers being provided for each of the plurality of fire monitoring zones to allow the air or air containing smoke flowing in through the smoke detection pipe from each of the plurality of fire monitoring zones to pass therethrough, wherein each of the plurality of sensing chambers is connected to one of the plurality of smoke detection pipes, and wherein each of the plurality of sensing chambers is provided with one of the plurality of light-receiving elements.

2. The multi-zone smoke detector according to claim 1, wherein the plurality of sensing chambers and the plurality of light-receiving elements are arranged centered around the light-emitting element.

3. The multi-zone smoke detector according to claim 2, wherein the plurality of sensing chambers are arranged at equal intervals around the light-emitting element.

4. The multi-zone smoke detector according to claim 2, wherein the light-emitting element has a cylindrical shape, a plurality of grooves are formed on a circumference of the light-emitting element, a sensing chamber boundary portion that divides adjacent sensing chambers in the housing is fitted within each of the plurality of grooves, and light is blocked between the adjacent sensing chambers by a structure in which each boundary portion of the housing is fitted in each of the plurality of grooves of the light-emitting element.

5. The multi-zone smoke detector according to claim 4, wherein each of the plurality of grooves extends in a lengthwise direction of the light-emitting element on the circumference of the light-emitting element.

6. The multi-zone smoke detector according to claim 2, wherein the light-receiving element is configured as a plate of a predetermined thickness, and is positioned on an inner surface of each of the plurality of sensing chambers at a position opposite to the light-emitting element.

7. The multi-zone smoke detector according to claim 2, wherein the housing is configured as a “□” shape, the light-emitting element is positioned at a center of the housing, and the plurality of sensing chambers and the plurality of light-receiving elements are arranged at four locations centered around the light-emitting element.

8. The multi-zone smoke detector according to claim 1, wherein an inlet port is positioned at a front of each of the plurality of sensing chambers, wherein each of the plurality of smoke detection pipes is connected to each of the inlet ports, wherein air or air containing smoke flows into each of the inlet ports into the housing, and wherein an exhaust port is positioned at a rear of each of the plurality of sensing chambers, wherein the air or the air containing smoke having passed through an interior of the plurality of sensing chambers is discharged through each of the exhaust ports.

9. A fire extinguishing system for a vehicle comprising:
a plurality of smoke suctioning and fire extinguishing fluid discharge pipes, each of the plurality of smoke suctioning and fire extinguishing fluid discharge pipes being positioned in each of a plurality of fire monitoring zones provided in the vehicle, and each of the plurality of smoke suctioning and fire extinguishing fluid discharge pipes having a nozzle for spraying a fire extinguishing fluid;
a plurality of smoke detection pipes connected to the plurality of smoke suctioning and fire extinguishing fluid discharge pipes through a control valve to selectively communicate with the plurality of smoke suctioning and fire extinguishing fluid discharge pipes;
an air compressor configured to apply suction pressure to the plurality of smoke detection pipes;
a multi-zone smoke detector configured to detect smoke in air flowing in through the nozzle and the plurality of smoke suctioning and fire extinguishing fluid discharge pipes from each of the plurality of fire monitoring zones by the suction pressure of the air compressor acting on the plurality of smoke suctioning and fire extinguishing fluid discharge pipes through the plurality of smoke detection pipes;
a controller configured to determine that a fire occurs when the smoke is detected through the multi-zone smoke detector, and to output a control signal for spraying the fire extinguishing fluid to one of the plurality of fire monitoring zones where the fire occurs through the nozzle;
and a fire extinguishing fluid supply device configured to supply the fire extinguishing fluid to the plurality of smoke suctioning and fire extinguishing fluid discharge pipes within the fire monitoring zone where the fire occurs according to the control signal output from the controller.

10. The fire extinguishing system according to claim 9, wherein the plurality of fire monitoring zones comprises one or more of a power electric (PE) compartment including PE parts, a battery compartment including a battery, and a stack compartment including a fuel cell stack.

11. The fire extinguishing system according to claim 9, wherein a fire extinguishing fluid supply pipe that supplies the fire extinguishing fluid from the fire extinguishing fluid supply device is branched and extended to each of the plurality of fire monitoring zones, and each of the branched extinguishing fluid supply pipes is connected through the control valve to selectively communicate with each of the smoke suctioning and fire extinguishing fluid discharge pipes within each of the fire monitoring zones.

12. The fire extinguishing system according to claim 11, wherein each of the branched fire extinguishing fluid supply pipes, the smoke suctioning and fire extinguishing fluid discharge pipe in each of the fire monitoring zones, and the smoke detection pipe provided for each of the fire monitoring zones are connected via each control valve, and an opening state of each control valve is controlled by the controller to allow communication between the fire extinguishing fluid supply pipes and the smoke suctioning and fire extinguishing fluid discharge pipes, or communication between the smoke detection pipes and the smoke suctioning and fire extinguishing fluid discharge pipes.

13. The fire extinguishing system according to claim 9, wherein the multi-zone smoke detector comprises:
a housing connected to each of the smoke detection pipes and configured to allow air or air containing smoke flowing in from each of the fire monitoring zones to pass through each of the smoke detection pipes;
a light-emitting element positioned in the housing; and
a plurality of light-receiving elements positioned in the housing facing the light-emitting element, and configured to convert light received from the light-emitting element into an electrical signal and to output the electrical signal;
wherein the housing comprises a plurality of sensing chambers, each of the plurality of sensing chambers being provided for each fire monitoring zone to allow air or air containing smoke flowing in through each of the smoke detection pipes from each of the plurality of fire monitoring zones to pass therethrough, each of the plurality of sensing chambers is connected to each of the smoke detection pipes, and each of the plurality of sensing chambers has the light-receiving element provided within the sensing chamber.

14. The fire extinguishing system according to claim 13, wherein the plurality of sensing chambers and the plurality of light-receiving elements are arranged centered around the light-emitting element.

15. The fire extinguishing system according to claim 14, wherein the light-emitting element has a cylindrical shape, a plurality of grooves are formed on a circumference of the light-emitting element, a sensing chamber boundary portion that divides adjacent sensing chambers in the housing is fitted in each of the plurality of grooves, and light is blocked between the adjacent sensing chambers when each boundary portion of the housing is fitted in each of the plurality of grooves of the light-emitting element.

16. The fire extinguishing system according to claim 13, wherein:
an inlet port is positioned at a front of each of the plurality of sensing chambers, wherein each of the plurality of smoke detection pipes is connected to each of the inlet ports, wherein air or air containing smoke flows into each of the inlet ports in the housing; and
an exhaust port is positioned at a rear of each of the plurality of sensing chambers, wherein the air or the air containing smoke having passed through the interior of the sensing chamber is discharged through each of the exhaust ports.

17. The fire extinguishing system according to claim 16, wherein the plurality of smoke detection pipes connected to the exhaust ports are combined and connected to a suction pipe, and the suction pipe is connected to the air compressor so that the suction pressure of the air compressor is applied to each smoke detection pipe through the suction pipe.

18. The fire extinguishing system according to claim 9, wherein the fire extinguishing fluid supply device comprises:
a fire extinguishing fluid tank in which the fire extinguishing fluid is stored; and
a pressure transfer plate that is configured to move by pressure of the fire extinguishing fluid supplied to a pressure chamber of the fire extinguishing fluid tank, and is configured to pressurize the fire extinguishing fluid filled in a fire extinguishing fluid chamber of the fire extinguishing fluid tank to discharge the fire extinguishing fluid to the fire extinguishing fluid supply pipe from the fire extinguishing fluid tank;
wherein the fire extinguishing fluid is compressed air supplied by the air compressor.

19. The fire extinguishing system according to claim 9, wherein the nozzle comprises:
a nozzle pipe having a first end portion in communication with each of the plurality of smoke suctioning and fire extinguishing fluid discharge pipes, and a second end portion through which air or air containing smoke within each of the fire monitoring zones flows in, or the fire extinguishing fluid is discharged and sprayed; and
a filter positioned in the nozzle pipe configured to remove foreign substances contained in the air or air and smoke suctioned through the second end portion of the nozzle pipe by the suction pressure of the air compressor.

20. The fire extinguishing system according to claim 9, wherein the controller is configured to determine a concentration of smoke in the air flowing in from each of the plurality of fire monitoring zones based on an electrical signal of the multi-zone smoke detector indicating the concentration of smoke in the air flowing in from each of the plurality of fire monitoring zones, a speed (RPM) of the air compressor, and a speed (RPM) of a cooling fan positioned in each of the plurality of fire monitoring zones.
